(19) United States
(12) Patent Application Publication
(10) Pub. No.: US 2022/0206195 A1
(43) Pub. Date: Jun. 30, 2022

(54) RETROREFLECTIVE ARTICLE COMPRISING MULTIPLE LAYERS THAT DIFFER IN REFLECTIVITY

(71) Applicant: 3M INNOVATIVE PROPERTIES COMPANY, St. Paul, MN (US)

(72) Inventors: Kui Chen-Ho, Woodbury, MN (US); Ying Xia, Woodbury, MN (US); Tien Yi T.H. Whiting, St. Paul, MN (US); David J. Rowe, Roseville, MN (US); Shri Niwas, Maple Grove, MN (US); Michael A. McCoy, St. Paul, MN (US); Scott J. Jones, Woodbury, MN (US); Kevin W. Gotrik, Hudson, WI (US); Graham M. Clarke, Woodbury, MN (US); Lok-Man Ng, Hsinchu City, Taiwan (CN)

(21) Appl. No.: 17/605,687

(22) PCT Filed: Apr. 24, 2020
(86) PCT No.: PCT/IB2020/053889

§ 371 Date: Oct. 22, 2021

Related U.S. Application Data
(60) Provisional application No. 62/838,580, filed on Apr. 25, 2019.

(51) Int. Cl. G02B 5/124; G02B 5/128

(52) U.S. Cl. CPC G02B 5/124; G02B 5/128

(57) ABSTRACT

A retroreflective article including a binder layer and a plurality of retroreflective elements. Each retroreflective element includes a transparent microsphere partially embedded in the binder layer. At least some of the retroreflective elements include a first layer that is disposed between the transparent microsphere and the binder layer and a second layer that is disposed between the transparent microsphere and the binder layer. At least one of the first layer and the second layer is a reflective layer; and, the first reflective layer and the second reflective layer differ in reflectivity. For at least some of the retroreflective elements, at least a portion of the second reflective layer is positioned in-parallel to the first reflective layer.

### BACKGROUND

Retroreflective materials have been developed for a variety of applications. Such materials are often used e.g. as high visibility trim materials in clothing to increase the visibility of the wearer. For example, such materials are often added to garments that are worn by firefighters, rescue personnel, road workers, and the like.

### SUMMARY

In broad summary, herein is disclosed a retroreflective article comprising a binder layer and a plurality of retroreflective elements. Each retroreflective element comprises a transparent microsphere partially embedded in the binder layer. At least some of the retroreflective elements comprise a first layer that is disposed between the transparent microsphere and the binder layer and a second layer that is disposed between the transparent microsphere and the binder layer. At least one of the first layer and the second layer is a reflective layer; and, the first reflective layer and the second reflective layer differ in reflectivity. For at least some of the retroreflective elements, at least a portion of the second reflective layer is positioned in-parallel to the first reflective layer. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary retroreflective article with exemplary first and second layers.

FIG. 2 is an isolated magnified perspective view of a single transparent microsphere and exemplary first and second layers.

FIG. 3 is an isolated magnified side schematic cross sectional view of a single transparent microsphere and exemplary first and second layers.

FIG. 4 is an isolated magnified top plan view of a single transparent microsphere and an exemplary first layer, viewed along the front-rear axis of the microsphere.

FIG. 5 is a side schematic cross sectional view of an exemplary transfer article comprising an exemplary retroreflective article, with the transfer article shown coupled to a substrate.

FIG. 6 is a side schematic cross sectional view of an exemplary retroreflective intermediate article, comprising a carrier layer bearing transparent microspheres with exemplary isolated reflective layers disposed thereon.

FIG. 7 presents retroreflectance as a function of wavelength and entrance angle, for a Comparative Example.

FIG. 8 presents retroreflectance as a function of wavelength and entrance angle, for another Comparative Example.

FIG. 9 presents retroreflectance as a function of wavelength and entrance angle, for a Working Example.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all non-photographic figures and drawings in this document are not to scale and are chosen for the purpose of illustrating different embodiments of the invention. In particular the dimensions of the various components are depicted in illustrative terms only, and no relationship between the dimensions, relative curvatures, etc. of the various components should be inferred from the drawings, unless so indicated.

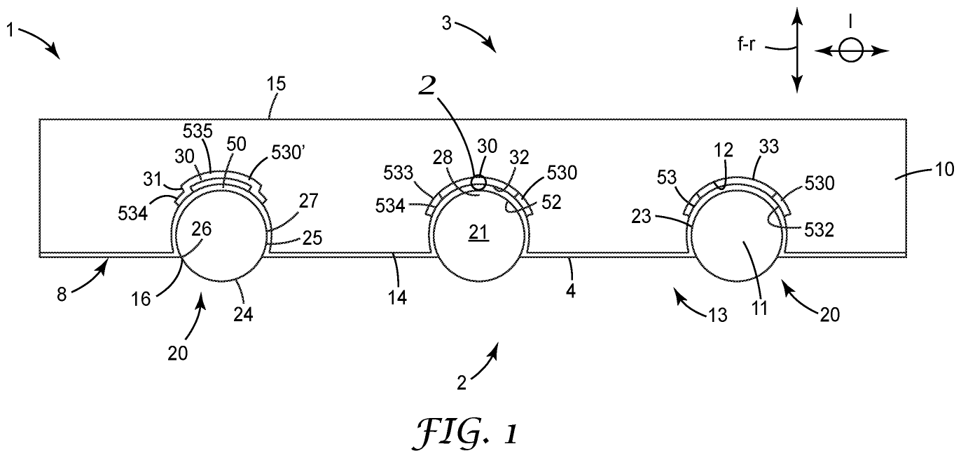

As used herein, terms such as “front”, “forward”, and the like, refer to the side from which a retroreflective article is to be viewed. Terms such as “rear”, “rearward”, and the like, refer to an opposing side, e.g. a side that is to be coupled to a garment. The term “lateral” refers to any direction that is perpendicular to the front-rear (forward-rearward) direction of the article, and includes directions along both the length and the breadth of the article. The front-rear direction (f-r), and exemplary lateral directions (l) of an exemplary article are indicated in FIG. 1.

Terms such as disposed, on, upon, atop, between, behind, adjacent, contact, proximate, and the like, do not require that a first entity (e.g. a layer) must necessarily be in direct contact with a second entity (e.g. a second layer) that the first entity is e.g. disposed on, behind, adjacent, or in contact with. Rather, such terminology is used for convenience of description and allows for the presence of an additional entity (e.g. a layer such as a bonding layer) or entities therebetween, as will be clear from the discussions herein.

By reflective is meant that an entity (e.g. a layer) is able to reflect “light”; in this context, “light” is defined as encompassing the visible spectrum and the infrared spectrum. A reflective layer as defined herein can thus reflect at least at some wavelength of visible light, at least at some wavelength of infrared light, or both. In quantitative terms, a reflective layer (which can comprise multiple sublayers as discussed herein) is a layer of material that, in a spectral reflectance curve obtained at normal incidence, exhibits a reflectance of at least 25 percent (%) at least at a selected wavelength or within a selected range of wavelength between 380 nanometer (nm) and 1 millimeter (mm), between 400 nm and 700 nm (e.g. a typical visible light wavelength range), or between 700 nm and 2500 nm (e.g. a typical near-infrared (IR) light wavelength range). In many embodiments the selected wavelength or range will be a wavelength or range of peak reflection exhibited by the layer. In some embodiments, a reflective layer may exhibit a reflectance of at least 40, 60, 80, or 90 percent at the selected wavelength or within the selected wavelength range. In some embodiments, a reflective layer may exhibit a reflectance of at least 40, 60, 80, or 90 percent, across the entirety of the visible light range, across the entirety of the near-infrared light range, or across both ranges.

By layers that differ in reflectivity is meant that the layers exhibit a difference in reflectance of at least 10 percent at any selected wavelength, or within any selected range of wavelength, between 380 nm and 1 mm, between 400 nm and 700 nm, or between 700 nm and 2500 nm, as discussed in detail later herein.

By transparent is meant that an entity (e.g. a layer) transmits at least 50 percent of light at a selected wavelength or within a selected range of wavelength between 380 nm and 1 mm, between 400 nm and 700 nm, or between 700 nm and 2500 nm. In some embodiments the transparent entity may transmit at least 60, 70, 80 or 90 percent of light at the selected wavelength or within the selected wavelength range. In some embodiments the transparent entity may transmit at least 60, 70, 80, or 90 percent of light across the entirety of the visible light range, the entirety of the near-infrared light range, or across both ranges. In some embodiments, the transparent entity may transmit at least 50 percent of light in the visible light spectrum and reflect at least 25 percent of light in the near-IR light spectrum. In some embodiments, the transparent entity may transmit at least 50 percent of light in the near-IR light spectrum and reflect at least 25 percent of light in the visible light spectrum. (It will thus be appreciated that some layers, e.g. certain wavelength-selective-reflecting dielectric stacks, may qualify as both a reflective layer and a transparent layer as defined herein.)

The terms “non-coextensive”, “in parallel”, and “in series” are defined and described in detail later herein.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). For angular orientations, the term “generally” means within clockwise or counterclockwise 10 degrees. The term “substantially”, unless otherwise specifically defined, means to a high degree of approximation (e.g., within +/−10% for quantifiable properties). For angular orientations, the term “substantially” means within clockwise or counterclockwise 5 degrees. The term “essentially” means to a very high degree of approximation (e.g., within plus or minus 2% for quantifiable properties; within plus or minus 2 degrees for angular orientations); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter. All averages referred to herein are number-average unless otherwise specified.

### DETAILED DESCRIPTION

FIG. 1 illustrates a retroreflective article 1 in exemplary embodiment. As shown in FIG. 1, article 1 comprises a binder layer 10 that comprises a plurality of retroreflective elements 20 spaced over the length and breadth of a front side of binder layer 10. Each retroreflective element comprises a transparent microsphere 21 that is partially embedded in binder layer 10 so that the microspheres 21 are partially exposed and define a front (viewing) side 2 of the article. The transparent microspheres thus each have an embedded (surface) area 25 that is seated in a receiving cavity 11 of binder layer 10, and an exposed area 24 that is exposed forwardly of major front surface 14 of binder layer 10. In some embodiments, the exposed areas 24 of microspheres 21 of article 1 are exposed to an ambient atmosphere (e.g., air) in the final article as-used, rather than being e.g. covered with any kind of cover layer or the like. Such an article will be termed an exposed-lens retroreflective article. In various embodiments, a microsphere may be partially embedded in the binder layer so that on average, from 15, 20 or 30 percent of the diameter of the microsphere, to about 80, 70, 60 or 50 percent of the diameter of the microsphere, is embedded within binder layer 10. In many embodiments, a microsphere may be partially embedded in the binder layer so that, on average, from 50 percent to 80 percent of the diameter of the microsphere is embedded within binder layer 10.

A retroreflective element 20 as defined herein will comprise at least one reflective layer disposed between the transparent microsphere 21 of the retroreflective element and the binder layer 10. The microsphere 21 and the reflective layer(s) collectively return a substantial quantity of incident light towards a source of light that impinges on front side 2 of article 1. That is, at least some of the light that strikes the retroreflective article's front side 2 passes into and through a microsphere 21 and is reflected by at least one reflective layer to again reenter the microsphere 21 such that the light is steered to return toward the light source.

At least some retroreflective elements 20 will each comprise a first layer 30 that is disposed between the transparent microsphere 21 and the binder layer 10 and that covers a first area of the embedded area 25 of the transparent microsphere, as illustrated in exemplary embodiment in FIG. 1. At least some of the retroreflective elements 20 that comprise a first layer 30 will also comprise a second layer 530 that is likewise disposed between the transparent microsphere 21 and the binder layer 10 and that covers a second area of the embedded area 25 of the transparent microsphere. The first and second layers may be disposed in any of numerous possible arrangements, as discussed in detail herein.

At least one of first layer 30 and second layer 530 is a reflective layer as defined herein. In various embodiments, any such reflective layer may exhibit a reflectance of at least 25 percent at least at a selected wavelength or within a selected range of wavelength between 380 nm and 1 mm, between 400 nm and 700 nm, or between 700 nm and 2500 nm.

The first layer 30 and the second layer 530 will differ in reflectance. As defined above, this means that the layers exhibit a difference in reflectance of at least 10 percent at any selected wavelength or within any selected range of wavelength between 380 nm and 1 mm, between 400 nm and 700 nm, or between 700 nm and 2500 nm. In various embodiments, first and second layers may exhibit a difference in reflectance of at least 20, 40, 60, 80, or 90 percent at a selected wavelength or within a selected range of wavelength between 380 nm and 1 mm, between 400 nm and 700 nm, or between 700 nm and 2500 nm. The percentage difference is in absolute terms and is evaluated at the wavelength of maximum difference in reflectance. Often, the greatest percentage difference in reflection may occur at a wavelength of peak reflection of one of the layers. By way of a specific example, if one layer exhibits a reflectance of 70 percent at some wavelength (e.g. a wavelength of peak reflection) and the other layer exhibits a reflectance of 40 percent at that same wavelength, the layers differ in reflectance by 30 percent.

For these and any other evaluations presented herein requiring measurement of reflectance, it is stipulated that even if the layers, as present on the microspheres, are e.g. too small to permit a direct measurement of their in situ reflectance in a retroreflective article, these definitions will be applied to measurement of layers of these same materials in a format that allows their reflectance to be evaluated. Of course, for many such layers it may be possible to obtain a reliable estimate of the reflectance from retroreflectance measurements of a retroreflective article bearing the layers.

In some embodiments, one layer (e.g. the second layer) may be reflective and the other layer (e.g. the first layer) may be transparent. However, in many embodiments both of the layers may be reflective but differ in their reflectivity at a selected wavelength or within a selected range of wavelength between 380 nm and 1 mm, between 400 nm and 700 nm, or between 700 nm and 2500 nm. For example, a first layer may be configured to exhibit a predetermined wavelength of peak reflection in some portion of the visible range, while a second layer may be configured to exhibit a predetermined wavelength of peak reflection in some other portion of the visible range or in the near-infrared (IR) range. It will be appreciated that numerous variations are possible within these overall guidelines; some exemplary arrangements are discussed later herein.

For at least some of the retroreflective elements 20 that comprise a first layer 30 and a second layer 530, the first area of the embedded area 25 of the transparent microsphere that is covered by first layer 30, and the second area of the embedded area 25 of the microsphere that is covered by second layer 530, are non-coextensive. By this is meant that the second area that is occupied by second layer 530, does not share the exact same size and shape as the first area that is occupied by first layer 30. Examples of such arrangements are shown in generic representation in various Figures herein. (It will be understood that any small differences in area coverage as may occur e.g. in real-life vapor deposition processes in which shadowing effects may randomly and occasionally occur, will not correspond to a non-coextensive arrangement as defined herein.)

This will have the result that at least a portion of second layer 530 is positioned in parallel to the first layer 30. The term in parallel signifies a portion of a second layer 530 (e.g. portions 534 in FIG. 1) that can be reached by light rays that impinge on the retroreflective element from the front, without those light rays having to pass through any portion of the first layer 30. In some embodiments the entirety of a second layer 530 may be made up of portions 534 that are in parallel to a first layer 30; in other embodiments only a portion of a second layer may be in parallel to a first layer, as will be made clear by the discussions below.

This application will use the terminology that a “second” layer will be a layer that exhibits at least a portion that is located in parallel to the other (first) layer. However, in some embodiments each layer may have a portion that is located in parallel to the other layer (e.g. if the layers are offset from each other). In any case, the terms first and second do not necessarily imply any kind of forward-rearward order or position, or order of formation. (However, in some embodiments, at least a portion of the “second” layer may be rearward of at least a portion of the first layer and/or the second layer may have been formed after the first layer.)

In some embodiments at least a portion 535 of a second layer 530 may be positioned “in series” with a first layer 30. The term in series signifies a portion of a second layer (e.g. portion 535 of the particular second layer denoted 530′ in FIG. 1) that is positioned generally rearward of a first layer 30, so that light rays that impinge on the retroreflective element from the front have to pass through the first layer 30 to reach the “in-series” portion 535 of the second layer.

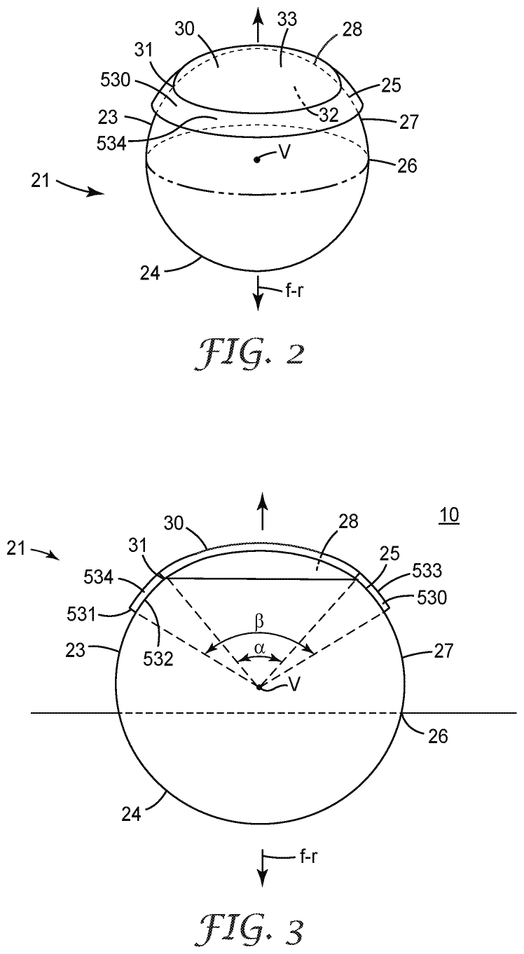

In some embodiments no portion of a second layer 530 may be positioned in series with a first layer 30. In other words, for some retroreflective elements 20 a portion 535 as shown for second layer 530′ in FIG. 1, may not be present. For example, in some embodiments a second layer 530 may be provided only as a partial, or complete, spherical segment (e.g. segments 534 of FIGS. 1, 2 and 3) that at least partially circumscribes a first layer 30 e.g. in the general manner of second layers 530 as shown in FIGS. 2 and 3, without any significant portion of second layer 530 being positioned rearward of (in series with) any portion of first layer 30.

In other embodiments a significant portion 535 of second layer 530 may be positioned rearward of (in series with) a first layer 30, in the general manner of portion 535 of the particular second layer denoted 530′ of FIG. 1. In at least some such cases, a second layer 530 that comprises an in-series portion 535 will also include a significant portion 534 that is in parallel to the first layer 30, as evident from FIG. 1.

Thus in summary, in some embodiments a second layer 530 may be present only as a spherical segment that at least partially circumscribes the first layer but does not rearwardly overlap the first layer to any significant extent (and thus is positioned in-parallel thereto). Such an instance is depicted in exemplary, generic representation for the particular second layers labeled 530 in FIGS. 1, 2 and 3. In other embodiments a second layer may be configured so that a portion 535 of it rearwardly overlaps the first layer and is positioned in-series thereto, as depicted in exemplary, generic representation for the particular second layer labeled 530′ in FIG. 1.

Whether or not a second layer 530 includes a portion 535 that is in series with a first layer 30, the second layer 530 will comprise at least a portion 534 that is in parallel to the first layer 30. In many embodiments such a portion 534 will form an at least partial spherical segment that at least partially circumscribes the first layer 30. Such an arrangement is depicted in exemplary, generic representation in the magnified, isolated views of FIGS. 2 and 3. In the particular arrangements of FIGS. 2 and 3, portion 534 of second layer 530 is a complete spherical segment rather than a partial spherical segment; that is, portion 534 completely circumscribes first layer 30. In other embodiments a second layer 530 may comprise an in-parallel portion 534 that only partially circumscribes a first layer 30. A second layer portion 534 that is a complete spherical segment will resemble a complete, uninterrupted annulus when viewed along the front-rear axis of the transparent microsphere; a second layer portion 534 that is a partial spherical segment will resemble a partial annulus when viewed in this manner. It will be understood that the term spherical segment is used for convenience to denote a second layer that generally circumscribes a first layer when viewed in this manner; it does not imply that the spherical segment must necessarily take the form of a perfect annulus nor does it imply that a radially-outer perimeter or a radially-inner perimeter of such a segment need take the shape of a perfect circle.

FIG. 2, referred to briefly above, is a magnified isolated perspective view of a transparent microsphere 21 with exemplary first and second layers 30 and 530 disposed thereon, with a binder layer 10 omitted for ease of visualizing layers 30 and 530. FIG. 3, also referred to briefly above, is a magnified isolated side schematic cross sectional view of a transparent microsphere with exemplary first and second layers 30 and 530 disposed thereon. As shown in FIGS. 1, 2 and 3, a first layer 30 will comprise a major forward surface 32 that often exhibits a generally arcuate shape, e.g. in which at least a portion of forward surface 32 at least generally conforms to a portion of a major rearward surface 23 of microsphere 21. In some embodiments, major forward surface 32 of reflective layer 30 may be in direct contact with major rearward surface 23 of microsphere 21; however, in some embodiments major forward surface 32 of reflective layer 30 may be in contact with a layer that is itself disposed on major rearward surface 23 of microsphere 21, as discussed in further detail later herein. A layer that is disposed in this manner may be, e.g., a transparent layer that serves e.g. as a protective layer, as a bonding layer, a tie layer or adhesion-promoting layer; or, such a layer may be a color layer as discussed in detail later herein. A major rearward surface 33 of reflective layer 30 may be in contact with forward-facing surface 12 of binder layer 10 as shown in FIG. 1, or a surface of a layer present thereon.

Similarly, a portion 534 (e.g. a portion that is arranged in-parallel with a first layer 30) of a second layer 530 may comprise a major forward surface 532 that often exhibits a generally arcuate shape, e.g. in which at least a portion of forward surface 532 at least generally conforms to a portion of a major rearward surface 23 of microsphere 21. In some embodiments, major forward surface 532 of this portion of second layer 530 may be in direct contact with major rearward surface 23 of microsphere 21; however, in some embodiments major forward surface 532 of reflective layer 530 may be in contact with a layer that is itself disposed on major rearward surface 23 of microsphere 21, in a similar manner as discussed above.

In some embodiments, a second layer 530′ may also comprise a portion 535 (e.g. a portion that is arranged rearwardly of, and in-series with, a first layer 30) that comprises a major forward surface that at least generally conforms to a portion of a major rearward surface 33 of first layer 30. In some embodiments, the major forward surface of this portion of second layer 530′ may be in direct contact with major rearward surface 33 of first layer 30 or with a rearward surface of some layer disposed thereon. A major rearward surface 533 of second layer 530′ may be in contact with forward-facing surface 12 of binder layer 10 as shown in FIG. 1, or a surface of a layer present thereon.

The locations of the embedded area of a transparent microsphere that are covered by a first layer 30 and/or a second layer 530, the relative sizes of the first and second layers, and so on, may be varied as disclosed herein. Such arrangements may be discussed with respect to the exemplary arrangements depicted in idealized, generic representation in FIGS. 1, 2 and 3, and may be characterized e.g. by an angular arc occupied by each layer.

In various embodiments, a first layer 30 may occupy an angular arc α (measured from minor outer edges 31 of layer 30, from a vertex “V” at the geometric center of the microsphere, as indicated in FIG. 3) that is e.g. no more than 135, 90, 70, 50, 40, 30, 20, or 10 degrees. In further embodiments, the first layer 30 may occupy an angular arc α that is at least 5, 15, 25, 35, 45, 55, 60, 65 or 80 degrees. By way of a specific example, the first layer 30 shown in FIG. 3 occupies an angular arc α of approximately 80-85 degrees. In some embodiments, such a first layer 30 may be at least generally, substantially or essentially centered on the front-rear centerline of the transparent microsphere (i.e., centered on the rearwardmost point or “north pole” of the microsphere, as in the exemplary arrangements of FIGS. 2 and 3). Even if the first layer is not centered on the front-rear centerline, in many embodiments the centerline may pass through the first layer, as discussed in detail below.

A second layer 530 may comprise a portion 534 that is in parallel to the first layer 30, which portion is e.g. in the form of an at least partial spherical segment that is positioned radially outward of the first layer 30 and at least partially circumscribes the first layer. The second layer may occupy an angular arc β that is e.g. more than 10, 20, 30, 50, 60, 70, 90, 110, 130, 150 or 170 degrees. Such an angular arc β is measured from the perimeter of the second layer (i.e. from minor outer edges 531 of layer 530) and disregards whether or not the second layer includes only a spherical segment portion 534 or also includes an in-series portion 535 that overlaps the first layer. By way of a specific example, the second layer 530 shown in FIG. 3 occupies an angular arc of approximately 125-135 degrees. In some embodiments, such a second layer 530 may be at least generally, substantially or essentially centered on the rearwardmost point of the transparent microsphere, in similar manner to the first layer 30.

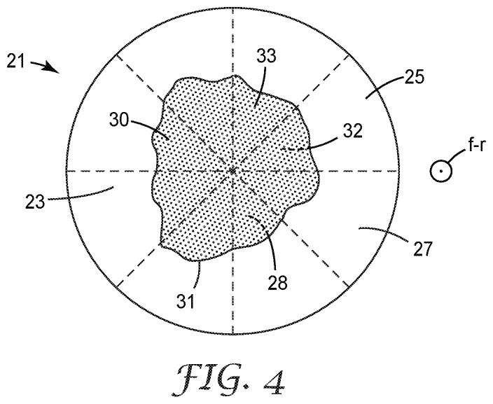

As will be made clear by the discussions later herein regarding methods of making first and second layers, in many embodiments such a layer may not necessarily be symmetrical (e.g., circular and/or centered on the front-rear centerline of the transparent microsphere) when viewed along the front-rear axis of the transparent microsphere. This is illustrated with reference to FIG. 4, which is a generic depiction of a transparent microsphere, viewed along the front-rear axis of the microsphere, and showing first layer 30. (Although only a first layer 30 is shown in FIG. 4, it will be understood that the following discussions apply in similar manner to a second layer 530.)

As evident from FIG. 4, in some cases a first layer 30 and/or a second layer 530 may be non-circular, e.g. oval, irregular, lop-sided, splotchy, etc., in the general manner shown in the generic representation of FIG. 4. Accordingly, if such a layer is to be characterized by an angular arc in the manner described above, an average value of the angular arc will be reported. Such an average value can be obtained, for example, by measuring the angular arc at several (e.g. four) locations spaced evenly around the microsphere (as exemplified by four dashed lines on top of the microsphere with the microsphere viewed along its front-rear axis) as indicated in FIG. 4 and taking the average of these measurements.

Methods of evaluating angular arcs of such layers (as well as other related parameters such as the percentage of the embedded area of the microsphere occupied by the layers, and the percentage of the total area of the microsphere occupied by the layers) are described in detail in U.S. Provisional Patent Application 62/739,489 and in PCT International Patent Application No. US2018/057561, both of which are incorporated by reference in their entirety herein. It will be appreciated that such parameters may be at least semi-quantitatively ascertained by use of photomicrographs of the general type found e.g. in the '489 and '561 applications.

For a layer that is symmetrically positioned on a microsphere e.g. as in FIGS. 1-3, the midpoint of any or all such angular arcs may at least substantially coincide with the front-rear axis (centerline) of the microsphere. That is, for a layer that is both symmetrically positioned and symmetrical shaped, the geometric center of the reflective layer may coincide with the front-rear centerline of the microsphere. However, in some embodiments a reflective layer may be at least slightly offset relative to the front-rear centerline of the microsphere, so that at least some such midpoints may be located e.g. 10, 20, 30, 45, 60, 75, or 85 degrees away from the front-rear centerline of the microsphere.

In additional to any individual first or second layer 30 or 530 possibly exhibiting an irregular shape as in FIG. 4, the layers that are present on different microspheres may differ from each other in shape and/or size. For example, in some embodiments the layers may be disposed on microspheres by being transferred to protruding portions thereof, while the microspheres are partially (and temporarily) embedded in a carrier. Since different microspheres may vary slightly in diameter, and/or there may be variations in the depth to which different microspheres are embedded in the carrier, different microspheres may protrude different distances outward from the carrier. In some cases microspheres that protrude further outward from the carrier may receive a greater amount of a layer transferred thereto, in comparison to microspheres that are more deeply embedded in the carrier. This being the case, it will be understood that the layers of various microspheres may differ from each other in terms of the angular arc occupied by the layer and/or in terms of the percentage of the embedded area of microsphere (or the percentage of the total area of the microsphere) occupied by the layer. Thus all such parameters may be reported as average values for an appropriate population.

In some particularly useful embodiments, a first layer 30 may be present in a relatively small area in comparison to the area occupied by the second layer 530, and may be located at or near the rearwardmost point of a transparent microsphere in the manner noted above. In particular embodiments, the first layer may be coincident with the front-rear centerline of the transparent microsphere (meaning that the centerline passes through some portion of the first layer), as in the exemplary embodiments of FIGS. 1-4. For convenience, such a first layer will be occasionally referred to herein by the shorthand of a “polar-cap” layer. Such a polar-cap first layer can be at least partially, e.g. completely, circumscribed by a second layer (e.g., the second layer can occupy an angular arc β that is greater than angular arc α of the first layer). Such arrangements can impart particular advantages as discussed in detail herein. In some particular embodiments a polar-cap first layer may occupy an angular arc α of no more than 40 degrees and a second layer may comprise an in-parallel segment that occupies an angular arc β of at least 80 degrees. In other particular embodiments, a polar-cap first layer may occupy an angular arc α of at least 80 degrees with the second layer comprising an in-parallel segment that occupies an angular arc β that is greater than 90 degrees.

However, in some embodiments the angular arc β occupied by a second layer may not necessarily be larger than the angular arc α occupied by a first layer (even though the second layer will still comprise a portion that is in parallel to a portion of the first layer). This may occur, for example, when the first and second layers are offset from each other in the general manner referred to previously.

First and second layers 30 and 530 will differ in their reflective character to at least the extent specified earlier herein. For example, in some embodiments second layer 530 may be reflective, while first layer 30 may be non-reflective, e.g. transparent as defined earlier herein. If a first, non-reflective layer 30 is present in a polar-cap configuration as described above, and is circumscribed on at least some sides by portions 534 of a second, reflective layer 530, a retroreflective element may be produced with unique properties. For example, a retroreflective element (and a retroreflective article comprising a collection of such elements) comprising a visibly-transparent first layer 30 in polar-cap configuration and a visibly-reflective second layer 530 in spherical segment configuration may exhibit visible-light retroreflectivity that, at least at some wavelengths, actually increases with increasing (i.e. more glancing) entrance angles of incident light.

Thus in some such embodiments, a first, e.g. polar-cap layer 30 may be non-reflective and may also serve e.g. to passivate a polar-cap region of a transparent microsphere so that a second, reflective layer will not bond to the polar-cap region. This may allow production of a retroreflective element having a second, reflective layer that is a purely spherical segment (rather than having a portion that is in-series to the transparent, polar-cap first layer) and having a non-reflective, e.g. transparent, polar-cap region. In various embodiments, such a first layer 30 may exhibit a total transmittance of at least 85, 90, or 95 percent from 380 nm to 2500 nm.

In some embodiments both first layer 30 and second layer 530 may be reflective, but may differ at least somewhat in their reflective character. In some embodiments, at least one of the reflective layers may be wavelength-selective; i.e., a layer that preferentially reflects light at a particular, e.g. predetermined, wavelength as defined and described below. In some such embodiments, one of the reflective layers (e.g. second layer 530) may be wavelength-selective with the other reflective layer (e.g. first layer 30) being non-wavelength-selective. A non-wavelength-selective reflective layer is any reflective layer that does not qualify as a wavelength-selective layer as defined herein. In many embodiments, a non-wavelength-selective layer may be a broad-spectrum, highly-reflective layer comprised of e.g. a layer of silver or aluminum. In other embodiments, both the first and second layers may be wavelength-selective reflective layers.

By way of a specific example, a first layer 30 (disposed e.g. in a polar-cap arrangement) may be a wavelength-selective reflective layer that is configured to preferentially reflect light that is somewhere within the near-infrared (IR) spectrum (e.g. encompassing a wavelength of approximately 700-2500 nm) light. Meanwhile, a second layer 530 (disposed e.g. in a spherical segment) may be a wavelength-selective reflective layer that is configured to preferentially reflect light that is somewhere within the visible spectrum (e.g. encompassing a wavelength of approximately 400-700 nm). A retroreflective article may thus be produced that, at relatively low (e.g. head-on) entrance angles of e.g. 0 to 5 degrees, preferentially reflects near-IR light; and, that at relative larger entrance angles (e.g. 30 degrees), preferentially reflects visible light. One arrangement that achieves this general type of behavior is demonstrated in Working Example 1 of the Working Examples herein. In other embodiments, the wavelength-selectivities of the first and second layers can be switched to produce a retroreflective article that preferentially reflects visible light at low entrance angles and preferentially reflects near-IR light at high entrance angles. And, of course, arrangements may be provided in which first and second layers preferentially reflect at different wavelengths within the visible light range or in which they preferentially reflect at different wavelengths within the infrared light range.

By preferentially reflect is meant that at a particular wavelength within the range of 380 nm to 1 mm, the layer exhibits a peak reflectance that is greater than a reflectance exhibited at some other wavelength within this range, by at least 20 percent, with the difference expressed in absolute terms. By way of a specific example, a wavelength-selective reflective layer that exhibits a peak reflectance of 80 percent at 600 nm and exhibits a reflectance of 20 percent at 900 nm, exhibits a peak reflectance that is greater than the 900-nm reflectance by 60 percent. In various embodiments a wavelength-selective reflective layer may exhibit a peak reflectance that is greater than a reflectance exhibited at some other wavelength by at least 30, 40, 50, 60, 70, 80 or 90 percent.

In various embodiments, first and second layers 30 and 530 can be configured to exhibit a peak reflection at wavelengths that differ from each other by a desired amount. As alluded to above, in some embodiments one layer may preferentially provide reflection in the visible range, while the other layer may preferentially provide reflection in the near-IR range. Or, in some embodiments one layer may preferentially provide reflection in one portion of the visible range, while the other layer may preferentially provide reflection in another, different portion of the visible range. In some embodiments, one or both layers may serve e.g. as a bandpass filter, a notch filter or the like. In various embodiments, the first and second layers may be chosen to exhibit respective wavelengths of peak reflection that differ by at least 50, 100, 200, 400, or 600 nm. In further embodiments, the first and second layers may be chosen to exhibit respective wavelengths of peak reflection that differ by no more than 10000, 5000, 2000, 1000, 800, 700, 500, or 300 nm.

In some embodiments, such a retroreflective element (and a retroreflective article comprising a collection of such elements) may exhibit retroreflectivity that, at least at some wavelengths, does not drop off as drastically with increasing entrance angles of incident light, as for conventional retroreflective articles. In fact, such elements and articles may exhibit retroreflectivity that, at least at some wavelengths, is actually greater at high entrance angles (e.g. measured at a 30 degree entrance angle of light) than at low, more “head-on” entrance angles (e.g. measured at a 5 degree entrance angle). Such arrangements are in contrast with conventional retroreflective articles and offer the possibility of many intriguing uses. One such arrangement that achieves this type of behavior is demonstrated in Working Example 1 of the Working Examples herein.

The above discussions have made it clear that the first and second layers can be any suitable layer with any desired configuration, property or function, as along as the first and second layers differ in reflectivity and at least one of the layers qualifies as a reflective layer as defined herein. For example, in some embodiments a first or second layer may be, or comprise, an optical retarder, meaning a layer that selectively slows one of the orthogonal components of light to change its polarization. In some embodiments, such an optical retarder may be configured as a quarter-wave retarder that, for a certain wavelength of interest has a retardance of λ/4. A quarter-wave retarder for a given wavelength of light will change the light of that wavelength from circularly polarized light to linear polarized light or vice versa. Optical retarders are described and discussed in detail in U.S. Provisional Patent Application 62/610,180 and in PCT International Patent Application No. IB2018/058406, both of which are incorporated by reference in their entirety herein. In some embodiments a first and/or second layer may comprise a colorant so as to be a color layer of the general type described in detail later herein.

In some particular embodiments, a second, e.g. reflective, layer may be provided that does not occupy the entirety of the embedded area of the transparent microsphere that is not occupied by a first, e.g. polar-cap reflective layer. In other words, in such an arrangement the microsphere may comprise an area 27 (e.g., near the “waist” 26 of the microsphere) that lacks any reflective layer as indicated in FIGS. 1, 2 and 3. In at least some embodiments, this may provide advantages. For example, this can provide that acceptable retroreflective performance is achieved (e.g. at least with light that impinges on the microspheres at relatively low (head-on) entrance angles), while also providing that the presence of the reflective layers does not significantly detract from the appearance of the article in ambient light. That is, in ambient light the article may exhibit an appearance that is largely imparted by the composition of the binder, in particular by any colorants or patterns that may be present in the binder, rather than being dominated by the presence of reflective layers.

Similar advantages may be obtained e.g. by using a second, e.g. spherical segment reflective layer, that exhibits wavelength-selectivity so as to preferentially reflect visible light at a certain wavelength and to pass visible light at other wavelengths. Such a second reflective layer (even if it covers the entirety of the embedded area of the microsphere that is not covered by the first reflective layer) may reflect sufficient incident light to meet any of various performance standards, while also allowing enough visible light to pass to allow a color imparted by the binder to be perceived.

In further detail, for a retroreflective article in which the entirety of the embedded areas of all of the microspheres of the article are covered with non-selective reflective layers, the reflective layers can dominate the appearance of the article in ambient light (e.g. so that the article exhibits a grey or washed-out appearance). In contrast, the present arrangements can provide that the “native” color of the article, e.g. as imparted by one or more colorants disposed in the binder layer, can be perceived in ambient light. In other words, enhanced color fidelity or vividness in ambient light can be provided.

In some embodiments a second reflective layer may be provided in such manner that, for some or all of the second layer, a radially inward edge of the second layer closely abuts a radially outward edge of the first layer, e.g. so that little or no light is able to penetrate therebetween. In other embodiments, a gap may be present between at least a portion of the radially outward edge of the first layer and the radially inward edge of the second layer.

In some embodiments a second reflective layer may be provided that does occupy (e.g., down to the “waist” of the microsphere) the entirety of the embedded area of the transparent microsphere that is not occupied by a first, e.g. polar-cap reflective layer. In various embodiments such a second reflective layer may be a wavelength-selective-reflective layer or a non-selective reflecting layer. For example, this may be achieved by disposing first, selective reflective layers onto microspheres in a polar-cap configuration, followed by disposing second, non-selective reflective layers (e.g. vapor-coated silver layers) so that the thus-formed second reflective layers cover the entirety of the embedded area of the microspheres that were not covered by the first reflective layers. While the thus-formed retroreflective article may not necessarily exhibit enhanced color fidelity in ambient light, it may nevertheless display retroreflective properties that are suited for particular applications.

It will thus be appreciated that the arrangements disclosed herein allow designers of retroreflective articles to operate in a design space in which the retroreflective performance, and/or the color/appearance in ambient light, of the article can be manipulated.

By way of one specific, non-limiting example, a retroreflective article may be produced with polar-cap first-layer reflectors (occupying, on average, an angular arc α of e.g. from 40 degrees up to 90 degrees) that are highly reflective (e.g., comprised of vapor-coated silver) at all relevant wavelengths. The article may have spherical-segment second-layer reflectors that are dielectric stacks chosen to exhibit reasonably good reflectivity at some visible-light wavelengths but that also are transparent (and, specifically, non-absorptive) to at least some wavelengths of visible light. In such an example, the second-layer reflectors may be present as spherical segments extending from an inner border located approximately at the outer perimeter of the first-layer reflectors, and occupying, on average, an angular arc β that is at least 2, 5, 10, 20, 30, 40, 50, or 60 degrees larger than that of the first-layer reflectors.

An article of this general type may display very good retroreflectivity to “head-on” visible light owing to the high reflectivity, at all visible-light wavelengths, of the first, polar-cap layers. The dielectric-stack second layers may provide sufficient visible-light retroreflectivity at off-angles (e.g. at an entrance angle up to 40 degrees) to, in combination with the “head-on” performance, allow the retroreflective article to meet any of various performance standards (e.g. a “32-angle” retroreflectivity standard in which retroreflectivity is measured at various entrance and observation angles, as will be familiar to artisans in the field). At the same time, the dielectric-stack second layers may be sufficiently transparent to allow the color of a binder layer of the retroreflective article (described later herein) to be visible, through the microspheres, in ambient light. In other words, the arrangements disclosed herein may allow the production of a retroreflective article that can pass any of various retroreflectivity performance tests while still allowing the native color of the article (e.g., fluorescent yellow, as imparted by a colorant in the binder layer) to be visible in ambient light.

The following discussions are couched primarily in terms of a single layer (e.g. a single reflective layer) but will be understood to be applicable to first layers and second layers. As illustrated in exemplary embodiment in FIG. 1, in some embodiments, at least some of the first layers 30 and/or second layers 530 of retroreflective elements 20 of retroreflective article 1 may be embedded layers. In some embodiments, at least generally, substantially, or essentially all of the first layers 30 of retroreflective elements 20 will be embedded reflective layers. In some embodiments, at least generally, substantially, or essentially all of the second layers 530 of retroreflective elements 20 will be embedded reflective layers.

An embedded layer is a layer that is disposed adjacent to a portion of an embedded area 25 of a transparent microsphere 21 as shown in exemplary embodiment in FIG. 1. An embedded layer will at least generally conform to a portion (often including a rearmost portion) of the embedded area 25 of a transparent microsphere 21. By definition an embedded layer will be completely surrounded (e.g. sandwiched) by the combination of at least the binder layer 10 and the transparent microsphere 21 (noting that in some embodiments some other layer or layers, e.g. an intervening layer such as a bonding layer and/or a color layer, may also be present in article 1, as discussed later herein, and may contribute to the surrounding of the embedded layer). In other words, the minor edges 31 of the layer (as depicted in exemplary embodiment in FIG. 1) will be “buried” between the transparent microsphere 21 and the binder layer 10 (and possibly other layers) rather than being exposed. That is, the locations 26 that mark the boundary between an exposed area 24 of a microsphere and an embedded area 25 of a microsphere (which locations may be referred to as the “waist” of the microsphere), will be abutted by an edge 16 of binder layer 10 (or an edge of layer disposed thereon) rather than by the minor edge 31 of layer 30.

For a transparent microsphere 21 that comprises an embedded layer 30, no part of embedded layer 30 will be exposed so as to extend onto (i.e., cover) any portion of exposed area 24 of microsphere 21. It will be appreciated that in actual industrial production of retroreflective articles of the general type disclosed herein, small-scale statistical fluctuations may inevitably be present that may result in the formation of a very small number of e.g. minor portions of a reflective layer that exhibit a minor edge or area that is exposed rather than being buried. Such occasional occurrences are to be expected in any real-life production process; however, embedded reflective layers as disclosed herein are distinguished from circumstances in which reflective layers are purposefully arranged in a manner in which they will exhibit a large number of exposed minor edges or areas.

In some embodiments a first embedded layer 30 and/or a second embedded layer 530 may be a localized layer. By definition, a localized layer is an embedded layer that does not comprise any portion that extends away from an embedded area 25 of a microsphere 21 along any lateral dimension of article 1 to any significant extent. In particular, a localized layer will not extend laterally to bridge lateral gaps between neighboring transparent microspheres 21. In some embodiments, at least generally, substantially, or essentially all (according to the previously-provided definitions) of the embedded layers 30 and/or 530 may be localized layers.

However, in some particular embodiments (e.g. involving laminated layers as discussed later herein) a layer may bridge a lateral gap between neighboring transparent microspheres. In such instances, a layer may be sized and positioned so that a portion of the layer is positioned at least generally rearwardly of a transparent microsphere, and another portion of that same layer is positioned at least generally rearwardly of another, neighboring microsphere. A single layer may thus operate (e.g. provide reflection) in conjunction with two (or more) transparent microspheres and will be termed a “bridging” layer. Bridging layers are not localized layers as defined herein, however, the perimeter edges of bridging layers are buried between the transparent microspheres and the binder material; bridging layers are thus “embedded” layers.

A first and/or second layer 30 and/or 530 may exhibit any suitable thickness (e.g. average thickness, measured at several locations over the extent of the layer). It will be appreciated that different methods of making a layer may give rise to layers of differing thickness. In various embodiments, a first or second layer may exhibit an average thickness of from at least 0.01, 0.05, 0.1, 0.2, 0.5, 1, 2, 4, or 8 microns, to at most 100, 80, 60, 40, 20, 10, 7, 5, 4, 3, 2 or 1 microns. In various other embodiments, a first or second layer may comprise an average thickness of at least 10, 20, 40 or 80 nanometers; in further embodiments such a layer may comprise an average thickness of at most 10, 5, 2 or 1 microns, or of at most 400, 200 or 100 nanometers. If the layer (or set of sublayers, e.g. of a dielectric stack that collectively provides a reflective layer) is a layer of a multilayer stack (e.g. a transfer stack as described later herein), these thicknesses apply only to the particular layer (e.g. the reflective layer) itself.

The present arrangements tolerate, and even make use of, significant variability in the first and/or second layers. That is, it will be appreciated from the discussions herein that at least some methods by which such layers are formed can result in significant variability in the size, shape, and so on, of the first layers and/or the second layers. Surprisingly, acceptable or even excellent retroreflective performance can be obtained in spite of such nonuniformity.

It will be appreciated that a population of nonuniform layers, e.g. reflective layers, as defined and described herein differs markedly from conventional, uniform populations of reflective layers as often described in the art. Conventional approaches (whether using transparent microspheres, prismatic elements such as cube-corners, etc.) typically seek to achieve as much uniformity in geometric parameters as possible. It is thus evident that the approaches disclosed herein differ sharply from conventional approaches to producing retroreflective articles. The present arrangements tolerate, and even welcome, considerable variation in the shape, size, etc. of the various layers, as long as the desired performance is obtained. As discussed herein, for various applications, such desired performance might be e.g. retroreflection whose wavelength-selectivity varies as a function of entrance angle, an overall balance between retroreflectivity in retroreflected light and color fidelity/vividness in ambient light, or some other desired behavior.

In some embodiments, a first layer 30 and/or a second layer 530 may be a reflective layer, e.g. a non-selective (e.g. full-spectrum) reflective layer. In some convenient embodiments, such a reflective layer may be a metal layer, e.g. a single layer, or multiple layers, of vapor-deposited metal (e.g. aluminum or silver). In some embodiments such a layer or layers (or precursor to form such a layer or layers) may be deposited directly onto areas 25 of transparent microspheres 21 (or onto rearward surface of 53 of an intervening layer 50, as discussed later herein). In some embodiments, portions of a previously-deposited (e.g. a continuous vapor-deposited) reflective layer may be removed (e.g. by etching) e.g. to transform the metal reflective layer into a localized, embedded reflective layer, as discussed later herein.

In some embodiments, a first layer 30 and/or a second layer 530 may be a reflective layer that is a wavelength-selective (e.g. preferentially-reflecting) layer. In some embodiments, such a reflective layer may comprise a dielectric stack reflective layer, comprised of an optical stack of high and low refractive index layers that combine to provide reflective properties. Such a dielectric stack could comprise, for example, alternating sublayers of a high-refractive-index material, such as a metal oxide, and a low-refractive-index organic polymeric material, so that the stack selectively exhibits a wavelength of peak (maximum) reflection in a desired range. Dielectric stacks of alternating high and low refractive index sublayers can be tailored in many and varied configurations to provide a desired selectivity of reflection. All such possible arrangements will not be discussed herein, but will be well known and available to ordinary artisans. Various exemplary arrangements are provided, for example, in U.S. Pat. Nos. 3,700,305 and 6,172,810, which are incorporated by reference in their entirety herein. Specific exemplary arrangements (e.g. a dielectric stack of total thickness in the range of 260-270 nm and with a wavelength of peak reflectivity in the range of 550-600 nm; and, a dielectric stack of total thickness in the range of 780-790 nm and with a wavelength of peak reflectivity in the range of approximately 850-950 nm) are disclosed in the Working Examples herein.

In some embodiments, the first layer and/or the second layer may comprise a dielectric stack that inherently produces a color due to light interference. Such a dielectric stack may comprise alternating high and low refractive index sublayers (e.g. zinc sulfide and calcium fluoride, respectively), or may comprise one light interference layer. The interference color uniformity may be controlled by the thickness and/or the refractive index of the dielectric stack layer or sublayers. In some embodiments, the interference color can be purposefully made non-uniform e.g. by varying the thickness of the individual layers of the dielectric stack. In particular embodiments, the first layer and/or the second layer may reflect light to give an iridescent (rainbow) effect in which the wavelength (and thus color) of the reflected light varies with the incidence angle. Dielectric stacks of this general type are described in detail in U.S. Pat. No. 8,684,544, which is incorporated by reference in its entirety herein for this purpose.

Various processes (for example, the process as described in Taiwanese patent TWI623636B to the Tung-Ho Vacuum Metallizing Company) can be used to deposit a non-uniform dielectric stack reflecting layer that can provide an article that exhibits an iridescent (rainbow) effect in reflected light. In particular embodiments, a retroreflective article may have first-layer reflectors (e.g., “polar-cap” reflectors as described earlier) that are highly reflective (e.g. that are made of metal). Such an article may have second-layer reflectors that are larger so as to have portions that are exposed beyond the edges of the first-layer reflectors, and that are wavelength-selective reflectors that exhibit an iridescent effect. Such an article may, for example, exhibit extremely high retroreflectivity in head-on light and may exhibit an iridescent effect in “off-angle” light.

In particular embodiments, a dielectric reflective layer may be a so-called layer-by-layer (LBL) structure in which each layer of the optical stack (i.e., each high-index layer and each low-index layer) is itself comprised of a substack of multiple bilayers. Each bilayer is in turn comprised of a first sub-layer (e.g. a positively charged sub-layer) and a second sub-layer (e.g. a negatively charged sub-layer). At least one sub-layer of the bilayers of the high-index substack will comprise ingredients that impart a high refractive index, while at least one sub-layer of the bilayers of the low-index substack will comprise ingredients that impart a low refractive index. LBL structures, methods of making such structures, and retroreflective articles comprising dielectric reflective layers comprising such structures, are described in detail in U.S. Patent Application Publication No. 2017/0276844, which is incorporated by reference in its entirety herein. In some embodiments a reflective layer thus may comprise multiple sublayers.

In some embodiments, a first layer 30 and/or a second layer 530 may comprise a printed layer, e.g. a printed reflective layer (e.g. comprising a reflective material such as metallic aluminum or silver). For example, a flowable precursor comprising one or more reflectivity-imparting materials (e.g., a silver ink) may be disposed (e.g. printed) on portions 28 of areas 25 of microspheres 21 (or on layers thereon) and then solidified into a reflective layer. If desired, a printed (or otherwise disposed) reflective layer may be heat treated (e.g. sintered) to enhance the optical properties of the reflective layer. In particular embodiments, a printed or coated reflective layer may further comprise particles, e.g. flakes, of reflective material (e.g. aluminum flake powder, pearlescent pigment, etc.). Various reflective materials which may be suitable are described in U.S. Pat. Nos. 5,344,705 and 9,671,533, which are incorporated by reference in their entirety herein. In some embodiments, the surface of a microsphere that is desired to be printed or coated upon may be treated e.g. to enhance or promote adhesion thereto. However, in some embodiments a layer to be coated or printed upon microspheres may exhibit good adhesion to glass; therefore, in some cases it may not be necessary to use any kind of intervening layer, in particular a bonding layer. Thus, such layers are not necessarily required for all embodiments.

In some embodiments, a first layer 30 and/or a second layer 530 may comprise a “locally-laminated” layer, e.g. a locally-laminated reflective layer. By a locally-laminated reflective layer is meant that a reflective layer is pre-made as an article (e.g. as part of a film-like or sheet-like structure) after which a local area of the pre-made reflective layer is physically transferred (i.e. laminated) to a portion of a carrier-borne transparent microsphere. In some embodiments a locally-laminated reflective layer will be derived from a multilayer “transfer stack” that includes one or more additional layers in addition to the reflective layer. The additional layer(s) can facilitate the transfer of the reflective layer to the transparent microsphere as discussed in detail later herein. In various embodiments, some such additional layers may remain as part of the resulting retroreflective article and some may be sacrificial layers that do not remain as part of the resulting retroreflective article.

First and second layers that are obtained by local lamination are described in detail in the U.S. Provisional Application No. 62/838,569, entitled RETROREFLECTIVE ARTICLE COMPRISING MULTIPLE LOCALLY-LAMINATED LAYERS; attorney docket number 81846US002, filed evendate on Apr. 25, 2019, which is incorporated by reference in its entirety herein.

As shown in exemplary embodiment in FIG. 1, in some embodiments an intervening layer 50 (e.g. a transparent layer of organic polymeric material) may be provided so that a portion, or the entirety, of the intervening layer is rearward of a microsphere 21 and forward of at least a portion of a first layer 30 and/or a second layer 530. At least a portion of such an intervening layer 50 may thus be sandwiched between microsphere 21 and layer 30 and/or 530, e.g. with a forward surface 52 of intervening layer 50 being in contact with a rearward surface of embedded area 25 of microsphere 21, and with a rearward surface 53 of intervening layer 50 being in contact with forward surface 32 of layer 30 or forward surface 532 of layer 530. In some embodiments such a layer 50 may be continuous so as to have portions that reside on front surface 4 of article 1 in addition to being present rearward of microspheres 21. Furthermore, even a “continuous” layer 50 may exhibit occasional through-holes or cavities in places where the layer precursor did not fully wet into gaps between the microspheres 21, as noted earlier. In various embodiments, an intervening layer may be one of the first and second layers as defined and described previously herein.

Such an intervening layer may serve any desired function. In some embodiments it may serve as a physically-protective layer and/or a chemically-protective layer (e.g. that provides enhanced abrasion resistance, resistance to corrosion, etc.). In some embodiments such a layer may serve as a bonding layer (e.g. a tie layer or adhesion-promoting layer) that is capable of being bonded to by a layer, e.g. a reflective layer. In some embodiments such a layer may serve as a passivation layer, as described previously herein. It will be appreciated that some intervening layers may serve more than one, e.g. all, of these purposes. In some embodiments, such an intervening layer may be transparent (specifically, it may be at least essentially free of any colorant or the like). Organic polymeric layers (e.g. protective layers) and potentially suitable compositions thereof are described in detail in U.S. Patent Application Publication No. 2017/0276844, which is incorporated by reference in its entirety herein. In particular embodiments, such a layer may be comprised of a polyurethane material. Various polyurethane materials that may be suitable for such purposes are described e.g. in U.S. Patent Application Publication No. 2017/0131444, which is incorporated by reference in its entirety herein.

In some embodiments at least some of the retroreflective elements may comprise at least one color layer. In various embodiments, a color layer may be one of the first and second layers as defined and described previously herein; or, a color layer may be a separate, additional layer. The term “color layer” is used herein to signify a layer that preferentially allows passage of electromagnetic radiation in at least one wavelength range between 380 nm and 1 mm, while preferentially minimizing passage of electromagnetic radiation in at least one other wavelength range between 380 nm and 1 mm by absorbing at least some of the radiation of that wavelength range. A color layer as defined herein performs wavelength-selective absorption of electromagnetic radiation by the use of a colorant (e.g. a dye or pigment) that is disposed in the color layer. A color layer is thus distinguished from a reflective layer (and from a transparent layer), as will be well understood by ordinary artisans based on the discussions herein. Color layers of various types are described in U.S. Provisional Patent Application 62/675,020 and in PCT International Patent Application No. US2018/057555. Any such color layer can be arranged so that light that is retroreflected by a retroreflective element passes through the color layer so that the retroreflected light exhibits a color imparted by the color layer. In some embodiments, a color layer may serve some other function (e.g. as a bonding layer, an adhesion-promoting layer, or a tie layer) in addition to imparting color to the retroreflected light.

In some embodiments a color layer may be a discontinuous color layer, e.g. a localized color layer. In particular embodiments a localized color layer may be an embedded color layer (with the terms localized and embedded having the same meanings as discussed above). The presence of color layers (e.g. localized, embedded color layers) in at least some of the retroreflective light paths of a retroreflective article can allow the article to comprise at least some areas that exhibit colored retroreflected light, irrespective of the color(s) that these areas (or any other areas of the article) exhibit in ambient (non-retroreflected) light.

Color layers and their use are described in detail in U.S. Provisional Patent Application No. 62/675,020 and in PCT International Patent Application No. US2018/057555, both of which are incorporated by reference in their entirety herein.

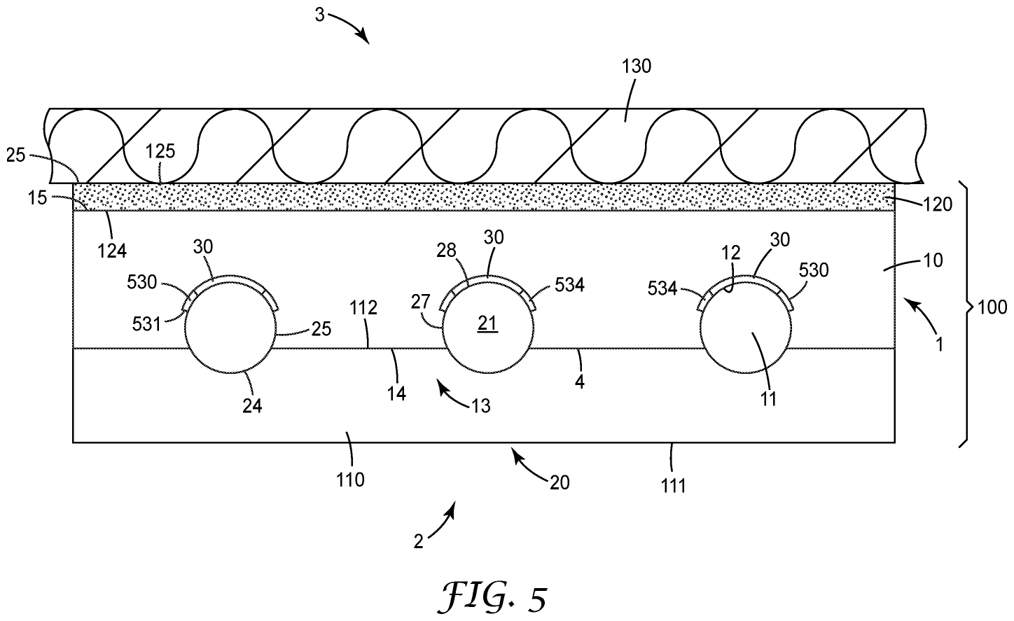

A retroreflective article 1 may be arranged to provide that the appearance of article 1 in ambient (non-retroreflected) light is controlled as desired. For example, in the exemplary arrangement of FIG. 5 the front surface 4 of article 1 will be provided (after removal of carrier 110) in part (e.g. in areas 8 of front side 2 of article 1 that are not occupied by transparent microspheres 21) by a visually exposed front surface 14 of binder layer 10. In such embodiments the appearance of front side 2 of article 1 in ambient light may thus be affected by the color (or lack thereof) of binder layer 10 in areas 13 of binder layer 10 that are laterally between microspheres 21. Similar effects may be achieved in arrangements of the type shown in FIG. 1, if continuous layer 50 is a transparent layer. Thus in some embodiments binder layer 10 may be a colorant-loaded (e.g. pigment-loaded) binder layer. The pigment may be chosen to impart any suitable color in ambient light, e.g. fluorescent yellow, green, orange, white, black, and so on. As noted, the arrangements herein can, in certain embodiments, allow the native color of the binder layer and retroreflective article to be more fully realized.

In some embodiments the appearance of retroreflective article 1 in ambient light may be manipulated e.g. by the presence and arrangement of one or more color layers on a front side of article 1. In some embodiments any such color layers, e.g. in combination with a colorant-loaded binder, may be configured so that the front side of article 1 exhibits a desired image (which term broadly encompasses e.g. informational indicia, signage, aesthetic designs, and so on) when viewed in ambient light. In some embodiments, article 1 may be configured (whether through manipulation of reflective layers and/or manipulation of any color layers in the retroreflective light path) to exhibit images when viewed in retroreflected light. In other words, any arrangement by which the appearance of article 1 in ambient light may be affected (e.g. by the use of a colorant-loaded binder, the use of colorant-loaded layers on the front side 4 of article 1, etc.) may be used in combination with any arrangement by which the appearance of article 1 in retroreflected light may be manipulated (e.g. by the use of color layers, e.g. localized, embedded color layers, in the retroreflective light path).

As noted, in some situations the appearance of article 1 in ambient light may be of lesser importance or may not be a significant consideration, e.g. in circumstances in which the wavelength-dependence of the article's retroreflectivity, in particular how this dependence changes with entrance angle, is of primary importance.

In some embodiments of the general type shown in FIG. 5, a retroreflective article 1 as disclosed herein may be provided as part of a transfer article 100 that comprises retroreflective article 1 along with a removable (disposable) carrier layer 110 that comprises front and rear major surfaces 111 and 112. In some convenient embodiments, retroreflective article 1 may be built on such a carrier layer 110, which may be removed for eventual use of article 1 as described later herein. For example, a front side 2 of article 1 may be in releasable contact with a rear surface 112 of a carrier layer 110, as shown in exemplary embodiment in FIG. 5.

Retroreflective article 1 (e.g. while still a part of a transfer article 100) may be coupled to any desired substrate 130, as shown in FIG. 5. This may be done in any suitable manner. In some embodiments this may be done by the use of a bonding layer 120 that couples article 1 to substrate 130 with the rear side 3 of article 1 facing substrate 130. Such a bonding layer 120 can bond binder layer 10 (or any layer rearwardly disposed thereon) of article 1 to substrate 130, e.g. with one major surface 124 of bonding layer 120 being bonded to rear surface 15 of binder layer 10, and with the other, opposing major surface 125 of bonding layer 120 bonded to substrate 130. Such a bonding layer 120 may be e.g. a pressure-sensitive adhesive (of any suitable type and composition) or a heat-activated adhesive (e.g. an “iron-on” bonding layer). Various pressure-sensitive adhesives are described in detail in U.S. Patent Application Publication No. 2017/0276844, which is incorporated by reference in its entirety herein.

The term “substrate” is used broadly and encompasses any item, portion of an item, or collection of items, to which it is desired to e.g. couple or mount a retroreflective article 1. Furthermore, the concept of a retroreflective article that is coupled to or mounted on a substrate is not limited to a configuration in which the retroreflective article is e.g. attached to a major surface of the substrate. Rather, in some embodiments a retroreflective article may be e.g. a strip, filament, or any suitable high-aspect ratio article that is e.g. threaded, woven, sewn or otherwise inserted into and/or through a substrate so that at least some portions of the retroreflective article are visible. In fact, such a retroreflective article (e.g. in the form of a yarn) may be assembled (e.g. woven) with other, e.g. non-retroreflective articles (e.g. non-retroreflective yarns) to form a substrate in which at least some portions of the retroreflective article are visible. The concept of a retroreflective article that is coupled to a substrate thus encompasses cases in which the article effectively becomes a part of the substrate.

In some embodiments, substrate 130 may be a portion of a garment. The term “garment” is used broadly, and generally encompasses any item or portion thereof that is intended to be worn, carried, or otherwise present on or near the body of a user. In such embodiments article 1 may be coupled directly to a garment e.g. by a bonding layer 120 (or by sewing, or any other suitable method). In other embodiments substrate 130 may itself be a support layer to which article 1 is coupled e.g. by bonding or sewing and that adds mechanical integrity and stability to the article. The entire assembly, including the support layer, can then be coupled to any suitable item (e.g. a garment) as desired. Often, it may be convenient for carrier 110 to remain in place during the coupling of article 1 to a desired entity and to then be removed after the coupling is complete. Strictly speaking, while carrier 110 remains in place on the front side of article 1, the areas 24 of transparent microspheres 21 will not yet be air-exposed and thus the retroreflective elements 20 may not yet exhibit the desired level of retroreflectivity. However, an article 1 that is detachably disposed on a carrier 110 that is to be removed for actual use of article 1 as a retroreflector, will still be considered to be a retroreflective article as characterized herein.

In some convenient embodiments, a retroreflective article 1 can be made by starting with a disposable carrier layer 110. Transparent microspheres 21 can be partially (and releasably) embedded into carrier layer 110 to form a substantially mono-layer of microspheres. For such purposes, in some embodiments carrier layer 110 may conveniently comprise e.g. a heat-softenable polymeric material that can be heated and the microspheres deposited thereonto in such manner that they partially embed therein. The carrier layer can then be cooled so as to releasably retain the microspheres in that condition for further processing.

Typically, the microspheres as deposited are at least slightly laterally spaced apart from each other although occasional microspheres may be in lateral contact with each other. The pattern (that is, the packing density or proportional area coverage) of microspheres as deposited on the carrier will dictate their pattern in the final article. In various embodiments, the microspheres may be present on the final article at a packing density of at least 30, 40, 50, 60 or 70 percent (whether over the entire article, or in microsphere-containing macroscopic areas of the article). In further embodiments, the microspheres may exhibit a packing density of at most 80, 75, 65, 55 or 45 percent (noting that the theoretical maximum packing density of monodisperse spheres on a plane is in the range of approximately 90 percent). In some embodiments the microspheres may be provided in a predetermined pattern, e.g. by using the methods described in U.S. Patent Application Publication 2017/0293056, which is incorporated by reference herein in its entirety.

In various embodiments the microspheres 21 may be partially embedded in carrier 110 e.g. to about 20 to 50 percent of the microspheres' diameter. The areas 25 of microspheres 21 that are not embedded in the carrier protrude outward from the carrier so that they can subsequently receive layers 30 and 530, and binder layer 10 (and any other layers as desired). These areas 25 (which will form the embedded areas 25 of the microspheres in the final article) will be referred to herein as protruding areas of the microspheres during the time that the microspheres are disposed on the carrier layer in the absence of a binder layer. In customary manufacturing processes, there may be some variation in how deeply the different microspheres are embedded into carrier 110, which may affect the size and/or shape of the reflective layers that are deposited onto portions of the protruding surfaces of the different microspheres.

A carrier layer comprising transparent microspheres thereon is described in the Working Examples herein as a Temporary Bead Carrier. Such a microsphere-bearing carrier, with an organic polymer intervening layer (e.g. a bonding layer) deposited thereon is referred to in the Working Examples as a Polymer Coated Bead Carrier. Further details of suitable carrier layers, methods of temporarily embedding transparent microspheres in carrier layers, and methods of using such layers to produce retroreflective articles, are disclosed in U.S. Patent Application Publication No. 2017/0276844.

After microspheres 21 are partially embedded in carrier 110 (and e.g. coated with an organic polymeric intervening layer), layers 30 and 530 (in some embodiments, at least some of which may become embedded layers after formation of binder layer 10) can be formed on portions of protruding areas 25 of at least some of the microspheres. A layer may be achieved by any method that can form a desired layer (or that can form a layer precursor that can solidify e.g. by drying, curing, or the like to form the actual layer) in such manner that the layer is embedded as defined and described herein. In some embodiments, first layers 30 and second layers 530 will be formed in separate, e.g. sequential operations. In some instances the second operation may be of the same type as the first operation, e.g. a second local lamination but performed using a reflective layer with different properties. However, in other instances the second operation may be a different type from the first operation.

In some embodiments, a process (e.g. a deposition process) that forms a smaller, e.g. polar-cap layer will be arranged to provide that the layer is formed only on portions of protruding areas 25 of microspheres 21 and not, for example, on the surface 112 of the carrier 110. For example, a contact-transfer process (e.g. flexographic printing, or lamination) may be used in which a layer (or precursor) is brought into contact with protruding areas of the microspheres so that the layer transfers to portions of the protruding areas of the microspheres without transferring to the surface of the carrier to any significant extent. Any such process may be controlled so that the layer (or precursor) is not disposed on the entirety of the protruding area 25 of a microsphere 21. That is, in some instances the process may be carried out so that a layer or precursor is transferred only to an outermost portion of the protruding area 25 of microsphere 21 (which outermost portion will become the rearmost portion of embedded area 25 of microsphere 21 in the final article). In some instances a layer may be transferred to a portion of the embedded area of the microsphere that is greater than the portion to be occupied by the layer in the final article, after which some part of the layer may be removed to leave only the desired area coverage.

Layers 30 and/or 530 may be disposed on portions of protruding areas 25 of (carrier-borne) transparent microspheres 21 by any suitable method or combinations of methods. This may be done e.g. by vapor deposition e.g. of a metal layer such as aluminum or silver, by deposition of numerous high and low refractive index layers to form a dielectric reflective layer, by printing (e.g. flexographic printing) or otherwise disposing a precursor comprising a reflective additive and then solidifying the precursor, by physically transferring (e.g. laminating) a pre-made reflective layer, and so on. In particular embodiments, a printable ink may comprise a precursor additive that can be transformed into a reflective material. For example, an ink might comprise silver in a form (e.g. such as silver cations or as an organometallic silver compound) that, after being printed onto desired areas, can be chemically reacted (e.g. reduced) to form metallic silver that is reflective. Commercially available printable silver inks include e.g. PFI-722 Conductive Flexo Ink (Novacentrix, Austin, Tex.) and TEC-PR-010 ink (Inktec, Gyeonggi-do, Korea).

Thus in some embodiments, layers 30 and/or 530 may be provided by printing a flowable material (e.g. an ink or ink precursor) on portions of protruding areas of carrier-borne transparent microspheres. Processes of this general type, in which a flowable precursor is deposited only onto certain portions of protruding areas of microspheres, will be characterized herein as “printing” processes. This will be contrasted with a “coating” process in which a material is deposited not only on protruding areas of the microspheres but also on the surface of the carrier, between the microspheres. In some convenient embodiments, such printing may comprise flexographic printing. Other methods of printing may be used as an alternative to flexographic printing. Such methods may include e.g. pad printing, soft lithography, gravure printing, offset printing, and the like. In general, any deposition method may be used, as long as the process conditions and the flow properties of the layer precursor are controlled to achieve the desired configuration of the first and/or second layer, e.g. so that the resulting layer is an embedded (e.g. localized) layer. It will be appreciated that whatever the method used, it may be advantageous to control the method so that the precursor is deposited in a very thin layer (e.g. a few microns or less) and at an appropriate viscosity, to provide that the precursor remains at least substantially in the area in which it was deposited. Such arrangements may ensure that, for example, the resulting layer occupies a desired portion 28 of embedded area 25 in the manner described above. It will also be appreciated that some deposition methods may provide a layer in which the thickness may vary somewhat from place to place. In other words, the rearward major surface 33 of a layer 30 may not necessarily be exactly congruent with the major forward surface 32 of the layer. However, at least some amount of variation of this type (as may occur e.g. with flexographic printing) has been found to be acceptable in the present work.

In some embodiments, a layer 30 and/or a layer 530 may be provided e.g. by forming a layer (e.g., a reflective layer, by vapor coating of a metal, or by printing or coating a reflective ink) onto a carrier and microspheres thereon, and then removing (e.g. by etching) the layer selectively from the surface of the carrier and from portions 27 of protruding areas 25 of the microspheres (before any binder layer is been formed) to leave e.g. localized layers in place on the microspheres. In some particular embodiments of this type, an etch-resistant material (often referred to as a “resist”) may be applied (e.g. by printing) on portions of a layer that are atop the protruding areas of the microspheres, but is not applied to other portions of the microsphere-residing layer and is not applied to the portions of the layer that reside on the carrier surface. An etchant can then be applied that removes the layer except the portions thereof that are protected by the resist. Such methods are described in further detail in U.S. Provisional Patent Application No. 62/578,343, which is incorporated by reference herein.

In some embodiments a layer 30 and/or a layer 530 may be provided by a local lamination process. A local lamination process is one in which a local area of a pre-made reflective layer is transferred to portion of a protruding area of a transparent microsphere. During this process, the local area of the reflective layer is detached from (breaks free of) a region of the reflective layer that previously (in the pre-made reflective layer before lamination) laterally surrounded the transferred area. The laterally-surrounding region of the reflective layer from which the local area was detached is not transferred to the microsphere (or to any portion of the resulting article) but rather is removed from the vicinity of the microsphere (e.g., along with other, sacrificial layers of a multilayer transfer stack of which the pre-made reflective layer was a part). The use of local lamination methods to provide first and second layers, e.g., reflective layers, are described in detail in U.S. Provisional Application No. 62/838,569 entitled RETROREFLECTIVE ARTICLE COMPRISING MULTIPLE LOCALLY-LAMINATED LAYERS; attorney docket number 81846US002, filed evendate herewith, which is incorporated by reference in its entirety herein. Local lamination methods are also described in detail in U.S. Provisional Patent Application 62/739,506 and in PCT International Patent Application No. US2018/057553, both of which are incorporated by reference in their entirety herein. The Working Examples in the present application also illustrate the use of local lamination methods to provide first and second layers 30 and 530.

While, for example, the above-noted 81846US002 application discloses the use of local lamination to form both first layers 30 and second layers 530, it is emphasized that in the present disclosure, if local lamination methods are used they may be used to form only first layers 30, to form only second layers 530, or to form both first and second layers 30 and 530. Also, while in the above discussions the various possible layer-forming methods have mainly dealt with forming reflective layers, it is emphasized that in some embodiments only first layers 30 or only second layers 530 need be reflective. For example, in some such embodiments either the first layers 30 or the second layers 530 may be non-reflective and e.g. non-absorbing (e.g. transparent). In such circumstances, an ordinary artisan would readily understand how to modify the above-discussed methods so that the layer in question was e.g. transparent.

After formation of the first and second layers is carried out, a binder can be disposed on microsphere-bearing carrier layer 110. In some embodiments this can be performed by disposing a binder precursor (e.g., a mixture or solution of binder layer components) to microsphere-bearing carrier layer 110. The binder precursor may be disposed, e.g. by coating, onto the microsphere-loaded carrier layer and then hardened to form a binder layer, e.g. a continuous binder layer. The binder may be of any suitable composition, e.g. it may be formed from a binder precursor that comprises an elastomeric polyurethane composition along with any desired additives, etc. Binder compositions, methods making binders from precursors, etc., are described in U.S. Patent Application Publication Nos. 2017/0131444 and 2017/0276844, which are incorporated by reference in their entirety herein. Binders, compositions thereof, and methods of making binders may also be chosen from those described in U.S. Provisional Application No. 62/522,279 and corresponding PCT International Patent Application No. US2018/038160; U.S. Provisional Application No. 62/527,090 and corresponding PCT International Patent Application No. IB2018/054778; U.S. Provisional Application No. 62/785,326; and U.S. Provisional Application No. 62/785,344, all of which are incorporated by reference herein in their entirety.

In general, binder layer 10 is configured to support transparent microspheres 21 and is typically a continuous, fluid-impermeable, sheet-like layer. In various embodiments, binder layer 10 may exhibit an average thickness of from 1 to 250 micrometers. In further embodiments, binder layer 10 may exhibit an average thickness of from 30 to 150 micrometers. Binder layer 10 may include polymers that contain units such as urethane, ester, ether, urea, epoxy, carbonate, acrylate, acrylic, olefin, vinyl chloride, amide, alkyd, or combinations thereof. A variety of organic polymer-forming reagents can be used to make the polymer. Polyols and isocyanates can be reacted to form polyurethanes; diamines and isocyanates can be reacted to form polyureas; epoxides can be reacted with diamines or diols to form epoxy resins, acrylate monomers or oligomers can be polymerized to form polyacrylates; and diacids can be reacted with diols or diamines to form polyesters or polyamides. Examples of materials that may be used in forming binder layer 10 include for example: Vitel™ 3550 available from Bostik Inc., Middleton, Mass.; Ebecryl™ 230 available from UBC Radcure, Smyrna, Ga.; Jeffamine™ T-5000, available from Huntsman Corporation, Houston, Tex.; CAPA 720, available from Solvay Interlox Inc., Houston Tex.; and Acclaim™ 8200, available from Lyondell Chemical Company, Houston, Tex.

In some embodiments binder layer 10 may be at least generally visibly transmissive (e.g. transparent). In many convenient embodiments binder layer 10 may comprise one or more colorants. In particular embodiments a binder may comprise one or more fluorescent pigments. Suitable colorants (e.g. pigments) may be chosen e.g. from those listed in the above-cited '444 and '844 Publications.

In some embodiments, binder layer 10 may contain reflective particles, e.g. flakes, of reflective material (e.g. nacreous or pearlescent material), so that at least a portion of binder layer 10 that is adjacent to transparent microsphere 21 can function as a secondary reflective layer. By a “secondary” reflective layer is meant a layer of binder layer 10 that serves to enhance the performance of a retroreflective element above the performance provided by first and/or second reflective layers 30 and/or 530 that cover an area 28 of a transparent microsphere. Such a “secondary” reflective layer by definition is not disposed between a transparent microsphere and the binder layer (rather, it is provided by a portion of the binder layer itself) and is thus distinguished from the previously-described first and second layers. In many embodiments, such a secondary reflective layer may mainly operate adjacent a portion (e.g. portion 27 as shown in FIG. 5) of embedded area 25 of the transparent microsphere 21 that is not covered by a first or second layer 30 or 530. Such a secondary reflective layer (which may not necessarily have a well-defined rearward boundary) may provide at least some retroreflection due to the aggregate effects of the reflective particles that are present in the layer. Secondary reflective layers are described in detail in U.S. Provisional Patent Application No. 62/739,529 and in PCT International Patent Application No. US2018/057558, both of which are incorporated by reference herein in their entirety.

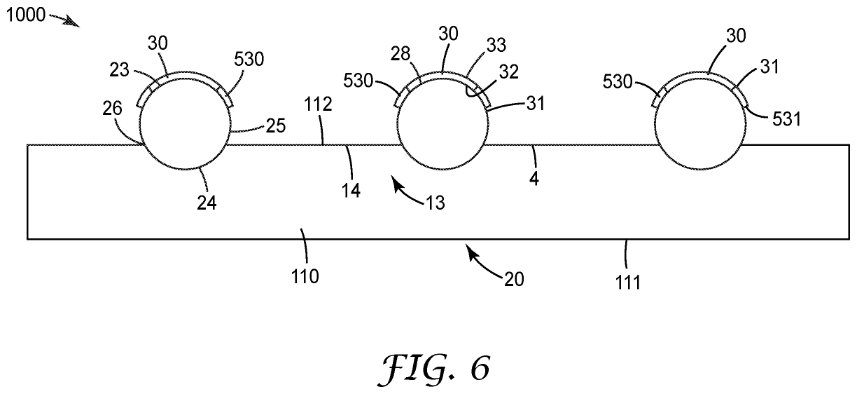

Discussions herein have primarily concerned articles of the general types shown e.g. in FIGS. 1 and 5 (including a binder layer, and in the form of e.g. a transfer article). However, in some embodiments the arrangements disclosed herein, comprising layers 30 and 530 or their equivalents, may be provided in an article that does not comprise a binder layer. Such an article will be termed an “intermediate” article for convenience of description. As shown in exemplary embodiment in FIG. 6, in embodiments of this type, an intermediate article 1000 may take the form of a carrier layer 110 bearing transparent microspheres 21 on a first surface 112 thereof, without any binder layer being present. (However, transparent microspheres 21 may be protected e.g. by a removable cover film provided on the microsphere-bearing side of the carrier layer, if desired.) Such an intermediate article will comprise at least some transparent microspheres 21 that comprise protruding areas 25 on portions 28 of which are disposed first layers 30 and second layers 530.

In some embodiments first layers 30 and/or second layers 520 may form embedded layers in the final article. However, strictly speaking, any such layers will not be “embedded” layers until a binder layer 10 is present. So, in embodiments of this particular type, such layers will be equivalently characterized as being “isolated” layers, meaning that they cover a portion, but do not cover the entirety, of the protruding areas 25 of the microspheres. The various characterizations of embedded layers in terms of the coverage of the microspheres, angular arcs, and so on, will be understood to be applicable in similar manner to isolated layers in intermediate articles in which a binder layer has not yet been disposed to form the final article.

In some embodiments, an intermediate article may comprise an intervening layer 50 of the general type described elsewhere herein. Other layers (e.g. color layers) may be included in the intermediate article as desired.

An intermediate article, comprising transparent microspheres with first and second layers 30 and 530 thereon, can be further processed as desired. In some embodiments, a binder layer e.g. comprising any desired colorant may be disposed onto the microsphere-bearing carrier layer in order to form an article 1. Intermediate articles of any suitable configuration may be shipped to customers who may, for example, dispose binder layers thereon to form customized articles.

Discussions herein have primarily concerned retroreflective articles in which areas 24 of microspheres 21 that are exposed (i.e., that protrude) forwardly of binder 10, are exposed to an ambient atmosphere (e.g., air) in the final retroreflective article as used. In other embodiments, the exposed areas 24 of microspheres 21 may be covered by, and/or reside within, a cover layer that is a permanent component of article 1. Such articles will be termed encapsulated-lens retroreflective articles. In such cases, the transparent microspheres may be chosen to comprise a refractive index that performs suitably in combination with the refractive index of the cover layer. In various embodiments, in an encapsulated-lens retroreflective article, the microspheres 21 may comprise a refractive index (e.g. obtained through the composition of the material of the microspheres, and/or through any kind of surface coating present thereon) that is at least 2.0, 2.2, 2.4, 2.6, or 2.8. In some embodiments, a cover layer of an encapsulated-lens retroreflective may comprise sublayers. In such cases, the refractive indices of the microspheres and the sublayers may be chosen in combination.

In some embodiments, such a cover layer may be a transparent layer. In other embodiments, the entirety, or selected regions, of a cover layer may be colored (e.g. may include one or more colorants) as desired. In some embodiments, a cover layer may take the form of a pre-existing film or sheet that is disposed (e.g. laminated) to at least selected areas of the front side of article 1. In other embodiments, a cover layer may be obtained by printing, coating or otherwise depositing a cover layer precursor onto at least selected areas of the front side of article 1, and then transforming the precursor into the cover layer.

As noted earlier herein, in some embodiments a color layer may be present that may perform wavelength-selective absorption of electromagnetic radiation at least somewhere in a range that includes visible light and infrared radiation, by the use of a colorant that is disposed in the color layer. Alternatively, or in addition, a colorant may be disposed in binder layer 10. The term colorant broadly encompasses pigments and dyes. Conventionally, a pigment is considered to be a colorant that is generally insoluble in the material in which the colorant is present and a dye is considered to be a colorant that is generally soluble in the material in which the colorant is present. However, there may not always be a bright-line distinction as to whether a colorant behaves as a pigment or a dye when dispersed into a particular material. The term colorant thus embraces any such material regardless of whether, in a particular environment, it is considered to be a dye or a pigment. Suitable colorants are described and discussed in detail in the aforementioned U.S. Provisional Patent Application 62/675,020.

Transparent microspheres 21 as used in any article disclosed herein may be of any suitable type. The term “transparent” is generally used to refer to a body (e.g. a glass microsphere) or substrate that transmits at least 50% of electromagnetic radiation at a selected wavelength or within a selected range of wavelengths. In some embodiments, the transparent microspheres may transmit at least 75% of light in the visible light spectrum (e.g., from about 400 nm to about 700 nm); in some embodiments, at least about 80%; in some embodiments, at least about 85%; in some embodiments, at least about 90%; and in some embodiments, at least about 95%. In some embodiments, the transparent microspheres may transmit at least 50% of radiation at a selected wavelength (or range) in the near infrared spectrum (e.g. from 700 nm to about 1400 nm). In various embodiments, transparent microspheres may be made of e.g. inorganic glass, and/or may have a refractive index of e.g. from 1.7 to 2.0. (As noted earlier, in encapsulated-lens arrangements, the transparent microspheres may be chosen to have a higher refractive index as needed.) In various embodiments, the transparent microspheres may have an average diameter of at least 20, 30, 40, 50, 60, 70, or 80 microns. In further embodiments, the transparent microspheres may have an average diameter of at most 200, 180, 160, 140 120, 100, 80, or 60 microns. The vast majority (e.g. at least 90% by number) of the microspheres may be at least generally, substantially, or essentially spherical in shape. However, it will be understood that microspheres as produced in any real-life, large-scale process may comprise a small number of microspheres that exhibit slight deviations or irregularities in shape. Thus, the use of the term “microsphere” does not require that these items must be e.g. perfectly or exactly spherical.

U.S. Patent Application Publication Nos. 2017/0276844 and 2017/0293056, which are incorporated by reference in their entirety herein, discuss methods of characterizing retroreflectivity according to e.g. a coefficient of retroreflectivity (R_{A}). In some embodiments, at least selected areas of retroreflective articles as disclosed herein may exhibit a coefficient of retroreflectivity, measured (at 0.2 degrees observation angle and 5 degrees entrance angle) in accordance with the procedures outlined in these Publications, of at least 20, 50, 100, 200, 250, 350, or 450 candela per lux per square meter. In some embodiments, the R_{A} may be highest when measured at a “head-on” entrance angle (e.g. 5 degrees). In other embodiments, the R_{A} may be highest when measured at a “glancing” entrance angle (e.g. 30, 40, or 50 degrees, or even 88.76 degrees).

In various embodiments, retroreflective articles as disclosed herein may meet the requirements of ANSI/ISEA 107-2015 and/or ISO 20471:2013 for minimum retroreflective coefficient performance at specific combinations of entrance and observation angle, such as the “32-angle” test battery of the type described in Table 5 of ISO 20471:2013 used in the evaluation of e.g. safety apparel.

In many embodiments, retroreflective articles as disclosed herein may exhibit satisfactory, or excellent, wash durability. Such wash durability may be manifested as high R_{A} retention (a ratio between R_{A} after wash and R_{A} before wash) after numerous (e.g. 25) wash cycles conducted according to the method of ISO 6330 2A, as outlined in U.S. Patent Application Publication No. 2017/0276844. In various embodiments, a retroreflective article as disclosed herein may exhibit a percent of R_{A} retention of at least 30%, 50%, or 75% after 25 such wash cycles. In various embodiments, a retroreflective article as disclosed herein may exhibit any of these retroreflectivity-retention properties in combination with an initial R_{A} (before washing) of at least 100 or 330 candela per lux per square meter, measured as noted above.

A retroreflective article as disclosed herein may be used for any desired purpose. In some embodiments, a retroreflective article as disclosed herein may be configured for use in or with a system that performs e.g. machine vision, remote sensing, surveillance, or the like. In particular, in many embodiments the herein-disclosed arrangements can provide a retroreflective article in which the wavelength dependence of the retroreflectivity changes with the entrance angle, in a manner (e.g. to an extent) not possible with e.g. conventional uniformly-reflectorized microspheres. Such behavior may be very advantageous for e.g. machine vision systems. Such a machine vision system may rely on, for example, one or more visible and/or near-infrared (IR) image acquisition systems (e.g. cameras or LIDARs) and/or radiation or illumination sources, along with any other hardware and software needed to operate the system. Thus in some embodiments, a retroreflective article as disclosed herein (whether or not it is mounted on a substrate) may be a component of, or work in concert with, a machine vision system of any desired type and configuration. Such a retroreflective article may, for example, be configured to be optically interrogated (whether by a visual-wavelength or near-infrared camera, e.g. at a distance of up to several meters, or even up to several hundred meters) regardless of the ambient light conditions. Thus in various embodiments, such a retroreflective article may comprise retroreflective elements configured to collectively exhibit any suitable image(s), code(s), pattern, or the like, that allow information borne by the article to be retrieved by a machine vision system. Exemplary machine vision systems, ways in which retroreflective articles can be configured for use in such systems, and ways in which retroreflective articles can be characterized with specific regard to their suitability for such systems, are disclosed in U.S. Provisional Patent Application No. 62/536,654, which is incorporated by reference in its entirety herein.

In some embodiments, reflective layers, color layers, and/or a cover layer (e.g. in the particular embodiment in which an article is an encapsulated-lens retroreflective article) may be provided in various macroscopic areas of a retroreflective article rather than collectively occupying the entirety of the article. Such arrangements can allow images to be visible in retroreflected light (whether such images stand out by way of increased retroreflectivity and/or by way of an enhanced color). In some embodiments, such images may be achieved e.g. by performing patterned deposition of the reflective layers. As noted earlier herein, in various embodiments a retroreflective article as disclosed herein may be configured to exhibit images when viewed in retroreflected light, to exhibit images when viewed in ambient light, or both. If both are present, the images when viewed in ambient light may be generally the same as those when viewed in retroreflected light (e.g. an article may convey the same information under both conditions); or the images may be different (e.g. so that different information is conveyed in ambient light versus in retroreflected light).

Various components of retroreflective articles (e.g. transparent microspheres, binder layers, reflective layers, etc.), methods of making such components and of incorporating such components into retroreflective articles in various arrangements, are described e.g. in U.S. Patent Application Publication Nos. 2017/0131444, 2017/0276844, and 2017/0293056, and in PCT International Patent Application No. PCT/US2018/057561, all of which are incorporated by reference in their entirety herein.

It will be appreciated that retroreflective elements comprising first and second layers as disclosed herein, can be used in any retroreflective article of any suitable design and for any suitable application. In particular, it is noted that the requirement of the presence of retroreflective elements comprising transparent microspheres (along with one or more color layers, reflective layers, etc.) does not preclude the presence, somewhere in the article, of other retroreflective elements (e.g. so-called cube-corner retroreflectors) that do not comprise transparent microspheres.

Although discussions herein have mainly concerned use of the herein-described retroreflective articles with garments and like items, it will be appreciated that these retroreflective articles can find use in any application, as mounted to, or present on or near, any suitable item or entity. Thus, for example, retroreflective articles as disclosed herein may find use in pavement marking tapes, road signage, vehicle marking or identification (e.g. license plates), or, in general, in reflective sheeting of any sort. In various embodiments, such articles and sheeting comprising such articles may present information (e.g. indicia), may provide an aesthetic appearance, or may serve a combination of both such purposes.

### Exemplary Embodiments

The disclosures presented herein include, but are not limited to, the following exemplary embodiments, arrangements and combinations.

Embodiment 1 is a retroreflective article comprising: a binder layer; and, a plurality of retroreflective elements spaced over a length and breadth of a front side of the binder layer, each retroreflective element comprising a transparent microsphere partially embedded in the binder layer so as to exhibit an embedded area of the transparent microsphere; wherein at least some of the retroreflective elements each comprise a first layer that is disposed between the transparent microsphere and the binder layer and that covers a first area of the embedded area of the transparent microsphere; wherein at least some of the retroreflective elements that comprise a first layer also comprise a second layer that is disposed between the transparent microsphere and the binder layer and that covers a second area of the embedded area of the transparent microsphere, wherein at least one of the first layer and the second layer is a reflective layer and wherein the first layer and the second layer differ in reflectivity, and wherein for at least some of the retroreflective elements that comprise a first layer and a second layer, the first area that is covered by the first layer and the second area that is covered by the second reflective layer are non-coextensive, so that at least a portion of the second layer is positioned in-parallel to the first layer so that incident light can reach the in-parallel portion of the second layer without having to pass through the first reflective layer.

Embodiment 2 is the retroreflective article of embodiment 1 wherein for at least some of the retroreflective elements the first layer is a relatively small reflective layer that covers a first, relatively small area of the embedded area of the transparent microsphere; and, the second layer is a relatively large reflective layer that covers a second, relatively large area of the embedded area that is larger than the first, relatively small area.

Embodiment 3 is the retroreflective article of any of embodiments 1-2 wherein for at least some of the retroreflective elements the second reflective layer comprises a radially-outward portion that is in-parallel to the first reflective layer and a radially-inward portion that is in-series with the first reflective layer so that incident light cannot reach the in-series portion of the second reflective layer without passing through the first reflective layer. Embodiment 4 is the retroreflective article of embodiment 3 wherein the radially-outward portion of the second reflective layer is an at least partial spherical segment that at least partially circumscribes the first reflective layer. Embodiment 5 is the retroreflective article of any of embodiments 3-4 wherein the radially-inward portion of the second reflective layer is positioned at least generally rearward of the first reflective layer, between the first reflective layer and the binder layer. Embodiment 6 is the retroreflective article of embodiment 2 wherein the first reflective layer is positioned at least generally rearward of a radially-inward portion of the second reflective layer, between the radially-inward portion of the second reflective layer and the binder layer.

Embodiment 7 is the retroreflective article of any of embodiments 1-6 wherein for at least some of the retroreflective elements the first layer is a reflective layer that is coincident with a front-rear centerline of the transparent microsphere; and, the second layer is a reflective layer configured so that the portion of the second reflective layer that is in-parallel with the first reflective layer is an at least partial spherical segment that at least partially circumscribes the first reflective layer. Embodiment 8 is the retroreflective article of embodiment 7 wherein for at least some of the retroreflective elements the portion of the second reflective layer that is in-parallel with the first reflective layer is a spherical segment that circumscribes the first reflective layer.

Embodiment 9 is the retroreflective article of any of embodiments 1, 2, 7 and 8 wherein for at least some of the retroreflective elements the second area covered by the second reflective layer is non-overlapping with the first area covered by the first reflective layer, so that the entirety of the second reflective layer is in-parallel to the first reflective layer.

Embodiment 10 is the retroreflective article of any of embodiments 1-8 wherein for at least some of the retroreflective elements the second reflective layer comprises a portion that is positioned at least generally rearward of the first reflective layer, between the first reflective layer and the binder layer, and that is in-series with the first reflective layer.

Embodiment 11 is the retroreflective article of any of embodiments 1-10 wherein the first reflective layers exhibit, on average, an angular arc of less than 40 degrees and wherein the second reflective layers exhibit, on average, an angular arc of greater than 60 degrees. Embodiment 12 is the retroreflective article of any of embodiments 1-10 wherein the first reflective layers exhibit, on average, an angular arc of at least 80 degrees.

Embodiment 13 is the retroreflective article of any of embodiments 1-12 wherein for at least some of the retroreflective elements that comprise first and second reflective layers, the transparent microsphere comprises an embedded area that is not covered by the first reflective layer or the second reflective layer.

Embodiment 14 is the retroreflective article of any of embodiments 1-13 wherein the first layers are non-wavelength-selective reflective layers. Embodiment 15 is the retroreflective article of any of embodiments 1-14 wherein the second layers are wavelength-selective reflective layers that exhibit a predetermined wavelength of peak reflection. Embodiment 16 is the retroreflective article of any of embodiments 1-13 and 15 wherein the first layer is a first wavelength-selective reflective layer configured to exhibit a first predetermined wavelength of peak reflection that is within the visible light spectrum and wherein the second layer is a second wavelength-selective reflective layer configured to exhibit a second predetermined wavelength of peak reflection that is within the near-IR spectrum. Embodiment 17 is the retroreflective article of any of embodiments 1-13 and 15 wherein the first layer is a first wavelength-selective reflective layer configured to exhibit a first predetermined wavelength of peak reflection that is within the visible light spectrum and wherein the second layer is a second wavelength-selective reflective layer configured to exhibit a second predetermined wavelength of peak reflection that is within the visible light spectrum, wherein the second predetermined wavelength of peak reflection differs from the first wavelength of peak reflection by at least 50 nm.

Embodiment 18 is the retroreflective article of any of embodiments 1-17 wherein the first layers and/or the second layers are embedded reflective layers. Embodiment 19 is the retroreflective article of any of embodiments 1-18 wherein the first layers and/or the second layers are localized reflective layers. Embodiment 20 is the retroreflective article of any of embodiments 1-18 wherein the first layers and/or the second layers are bridging reflective layers.

Embodiment 21 is the retroreflective article of any of embodiments 1-7, 9-12, 14 and 18-20 wherein the second layers are non-selective reflective layers comprising metal reflective layers that cover all portions of the embedded areas of the transparent microspheres that are not covered by the first layers.

Embodiment 22 is the retroreflective article of any of embodiments 1-21 wherein the first layers and/or the second layers comprise an optical retarder. Embodiment 23 is the retroreflective article of any of embodiments 1-22 wherein the first layers and/or the second layers comprise a colorant.

Embodiment 24 is a transfer article comprising the retroreflective article of any of embodiments 1-23 and a disposable carrier layer on which the retroreflective article is detachably disposed with at least some of the transparent microspheres in contact with the disposable carrier layer. Embodiment 25 is a substrate comprising the retroreflective article of any of embodiments 1-23, wherein the binder layer of the retroreflective article is coupled to the substrate with at least some of the retroreflective elements of the retroreflective article facing away from the substrate.

Embodiment 26 is an intermediate article comprising: a disposable carrier layer with a major surface; a plurality of transparent microspheres partially embedded in the disposable carrier layer so that the transparent microspheres exhibit protruding surface areas; wherein at least some of the transparent microspheres each comprise a first layer that is present on a portion of the protruding surface area of the transparent microsphere and a second layer that is present on a portion of the protruding surface area of the transparent microsphere, wherein at least one of the first layer and the second layer is a reflective layer and wherein the first layer and the second layer differ in reflectivity, and wherein for at least some of the transparent microspheres that comprise a first layer and a second layer, the first area that is covered by the first layer and the second area that is covered by the second layer are non-coextensive. Embodiment 27 is the intermediate article of embodiment 26 wherein the first layers and the second layers are isolated layers.

### EXAMPLES

In the following Working Examples, the first and second layers were disposed on transparent microspheres by local lamination methods, which are described in further detail in the U.S. Provisional Application entitled RETROREFLECTIVE ARTICLE COMPRISING MULTIPLE LOCALLY-LAMINATED LAYERS; attorney docket number 81846US002, filed evendate herewith, which is incorporated by reference in its entirety herein. However, it will be understood that these are merely exemplary methods of forming the herein-disclosed arrangements and that the performance (e.g. retroreflectivity, wavelength-selectivity, and so on) of the Working Examples are generally illustrative of retroreflective articles with first and second layers that differ in reflectivity as disclosed herein.

Materials, preparation methods and test methods used in the following Examples generally followed those used in U.S. Provisional Patent Application No. 62/739,506 and PCT International Application No. US2018/057553. The '506 application and the '553 application are incorporated by reference herein in their entirety.

### Test Methods

Coefficient of Retroreflection

Coefficients of reflection (R_{A} at e.g. an observation angle of 0.2° and an entrance angle of 5°), and color coordinates in ambient light conditions (Y, x, y) followed the same test methods as described in the above-cited '506 application. In some cases, samples were evaluated in a “32-angle” test battery of the type described in Table 5 of ISO 20471:2013 (and also referred to in ANSI/ISEA 107-2015) and often used in the evaluation of e.g. safety apparel.

Retroreflective Spectrum Measurement

Radiometric properties of retroreflective light of a retroreflective material was measured with an Ocean Optics Spectrometer (model FLAME-S-VIS-NIR), a light source (model HL-2000-FHSA), and a reflectance probe (model QR400-7-VIS-BX) over a geometry of an observation angle of 0.2° and an entrance angle of 5°, 20°, 30°, or 40°, at an integration time of 4 milliseconds on a sample area with 0.5 inch diameter. The retroreflective light was calibrated against a sheet of 3M™ Diamond Grade™ DG3 Prismatic Digital Sheeting 4090DS (White) at an observation angle of 0.2° and an entrance angle of 5°. The retroreflective spectrum was shown by percentage of reflectivity (Retroreflective R %) over a wavelength range from 400 to 1000 nanometers.

### Preliminary Articles and Methods of Making

Method for Making Temporary Bead Carrier Containing Glass Microspheres

The making of a temporary carrier sheet bearing transparent microspheres followed the same general process as outlined in the “Method for Making Temporary Bead Carrier containing Glass Microspheres” section of the '506 application. Disposing an organic polymeric layer on the microsphere-bearing carrier followed the same general process as described in the first paragraph of Working Example 2.3.1.D (Part D) of the '506 application. The resulting article is referred to as a Polymer Coated Bead Carrier.

Method for Making MultiLayer Transfer Stacks Comprising Reflective Layers

The making of transfer stacks comprising reflective layers in the form of dielectric stacks followed the same general process as described in Working Example 2.3.3.A (Part A) of the '506 application. Two such transfer stacks were made, one (designated R3502-5) comprising a dielectric-stack reflective layer that targeted at a wavelength of maximum reflection in the visible range, the other (designated R3512) comprising a dielectric stack reflective layer that targeted a wavelength of maximum reflection in the near-IR range. (These items may be referred to herein for convenience by the shorthand of visible-reflective and near-IR reflective.) The configurations of these two transfer stacks are shown in Tables 1 and 2. In these tables, all sublayer thicknesses are nominal targets based on deposition rate measurements or estimations; also, sublayers listed in these and other tables as “acrylate release” correspond to sublayers of the general type designated as “Acrylate-1” in the above-cited '506 and '553 application.

TABLE 1
Transfer Stack R3502-5
Visible dielectric transfer reflector R3502-5:

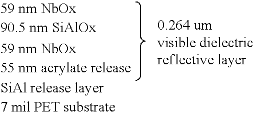

TABLE 2
Transfer Stack R3512
Near-IR dielectric transfer reflector R3512:

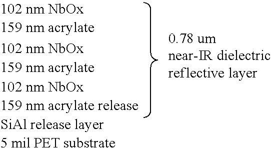

### COMPARATIVE EXAMPLES

Comparative Example 1 was made by laminating Transfer Stack R3502-5 to the Polymer Coated Bead Carrier. The lamination was performed using a pair of 16 inch diameter smooth-faced steel rolls, at a line speed of 3 feet per minute (fpm) and with a lamination pressure of 1000 pounds per linear inch (PLI) (these and all other laminations were performed at ambient temperature unless noted). The reflective layer of the Transfer Stack appeared to bond well to the organic polymer layer present on the protruding surfaces of the beads, and to separate from the surrounding reflective layer, so as to achieve the desired local lamination. After the lamination process, both the un-transferred reflective layer and the sacrificial layers of the Transfer Stack (comprising the SiAl release layer and the PET substrate) were removed from the microsphere-bearing carrier. A binder layer was then formed on the microsphere-bearing carrier, in generally similar manner as for Working Example 2.4.1 Part C of the '506 application. For convenience, the temporary carrier sheet was usually left in place on the article until such time as the article was to be tested, at which time the carrier sheet was removed and discarded. The resulting retroreflective article, which targeted retroreflectivity in the visible wavelength range, was designated as Comparative Example 1.

Comparative Example 2 was made in similar manner as Comparative Example 1, except using Transfer Stack R3512. Lamination conditions were the same. The retroreflective article, which targeted retroreflectivity in the near-IR wavelength range, was designated as Comparative Example 2.

### Working Example 1

In a first lamination procedure, a first Transfer Stack (R3512, comprising the near-IR reflective layer) was laminated to the Polymer Coated Bead Carrier. Lamination was performed using the pair of 16 inch diameter smooth-faced steel rolls, at a line speed of 3 feet per minute and with a lamination pressure of 800 pounds per linear inch (PLI). After the first lamination process, both the un-transferred reflective layer and the sacrificial layers of the Transfer Stack were removed from the microsphere-bearing carrier. The resulting article was then subjected to a second, subsequent lamination procedure.

In the second, subsequent lamination procedure, a second Transfer Stack (R3502-5, comprising the visible reflective layer) was laminated to the above-described product of the first lamination procedure. This lamination was performed using the pair of 16 inch diameter smooth-faced steel rolls, at a line speed of 3 feet per minute and with a lamination pressure of 1500 pounds per linear inch (PLI). After the lamination process, both the un-transferred reflective layer and the sacrificial layers of the Transfer Stack were removed from the microsphere-bearing carrier. A binder layer was then formed on the microsphere-bearing carrier, in generally similar manner as for Working Example 2.4.1 Part C of the '506 application. For convenience, the temporary carrier sheet was usually left in place on the article until such time as the article was to be tested, at which time the carrier sheet was removed and discarded.

The resulting retroreflective article was designated as Working Example 1. Working Example 1 was believed to comprise a majority of transparent microspheres on which were disposed first, near-IR-reflective layers in a relatively small, polar-cap configuration resulting from the first, relatively low-pressure lamination process. The majority of transparent microspheres also appeared to have disposed on them, second, visible-light-reflective layers, resulting from the second, more aggressive (higher pressure) lamination process. The second, visible reflective layers were believed to be present as relatively large spherical segments that at least generally circumscribed the first, near-IR-reflective polar-cap layers. It appeared that in most cases, the second reflective layers did not significantly bond to the exposed rearward surfaces of the first reflective layers and did not remain in place rearward of the first reflective layers. In other words, it appeared that under these particular conditions, the second reflective layers were present primarily as spherical segments positioned in-parallel to the first reflective layers, without the second reflective layers appearing to have significant portions positioned in-series to the first reflective layers.

Retroreflectance of Working Example 1 Versus Comparative Examples 1 and 2

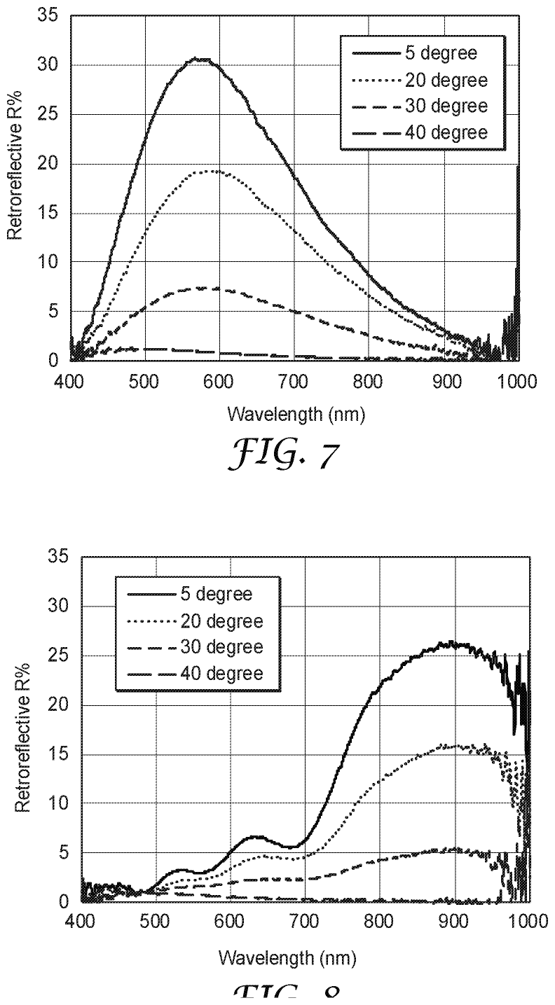

Retroreflective spectra (Retroreflective R % as a function of wavelength and as a function of entrance angle of the incident light) were obtained by the procedure outlined above, for Comparative Examples 1 and 2 and for Working Example 1. The respective results are shown in FIGS. 7, 8 and 9.

Inspection of FIG. 7 reveals that Comparative Example 1 exhibits a wavelength of peak reflection at approximately 580 nm, which is within the range targeted by the particular dielectric stack used in that sample. Furthermore, the wavelength of peak reflection does not change appreciably as the angle of incidence is changed from 5 degrees, to 20 degrees, then 30 degrees. These results demonstrate that the wavelength-selectivity of this sample is not dependent on the entrance angle of incident light over this range of entrance angle. Also, the reflectivity falls off rapidly with increasing entrance angle, indicating that the (single) reflective layer is present in a polar-cap configuration of the general type described previously herein.

Inspection of FIG. 8 reveals that Comparative Example 2 exhibits a wavelength of peak reflection at approximately 900 nm, which is within the range targeted by the particular dielectric stack used in that sample. Furthermore, the wavelength of peak reflection does not change appreciably as the angle of incidence is changed from 5 degrees, to 20 degrees, then to 30 degrees. These results demonstrate that the wavelength-selectivity of this sample is not dependent on the entrance angle of incident light over this range. (Again, the reflection falls off rapidly with increasing entrance angle, indicating that the reflective layer is present in a polar-cap configuration of the general type described previously herein.)

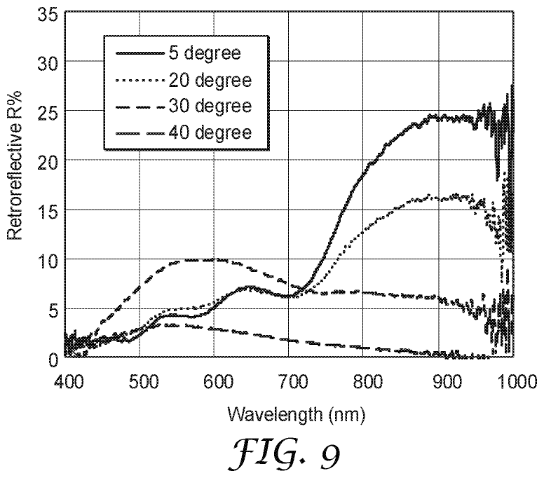

Inspection of FIG. 9 (Working Example 1) reveals that, at a 5 degree entrance angle, a wavelength of peak reflection at approximately 900 nm is exhibited. Very little reflection (e.g., Retroreflective R % of ˜4-5 at 550-600 nm) is observed in the visible range. As the entrance angle is increased to 20, and then 30 degrees, the near-IR retroreflectivity drops sharply while the visible retroreflectivity increases sharply. These results demonstrate wavelength-selectivity that depends on the entrance angle of incident light. This behavior is indicative of microspheres with polar-cap near-IR reflectors that dominate the retroreflectivity at near head-on entrance angles of e.g. 5 degrees, and with spherical-segment visible reflectors that exert an increasing effect at higher entrance angles of e.g. 30 degrees.

Notably, for Working Example 1, the Retroreflective R % in the range of 400-700 nm was actually higher when measured at an entrance angle of 30 degrees than when measured at an entrance angle of 5 degrees.

### Comparative Example 3

Comparative Example 3 was prepared following a similar procedure as described for Working Example 2.4.1 in the above-referenced '506 application, using a Transfer Stack that included a silver reflective layer, of a construction as shown in Table 3. (The combination of the Al release layer and the 1 mil BOPP substrate listed in the table, corresponded to “Heatseal Film-1” as referred to in the above-cited '506 and '553 applications.)

TABLE 3
Transfer Stack w/ Silver Reflective layer
Silver transfer reflector:

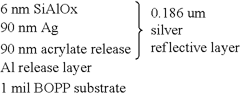

The transfer stack was laminated to the Polymer Coated Bead Carrier. In a process that varied somewhat from that described in Example 2.4.1 part B of the '506 application, the lamination was performed at 30 fpm (12.6 mm per second) and used a backing roll that was fitted with a silicone rubber sleeve of 68A Shore hardness. The lamination nip pressure was approximately 500 PLI. The silver reflective layer of the Transfer Stack appeared to bond well to the organic polymer layer present on the protruding surfaces of the beads, and to separate from the surrounding reflective layer, so as to achieve the herein-described local lamination. After the lamination process, both the un-transferred reflective layer and the sacrificial layers of the Transfer Stack were removed from the microsphere-bearing carrier. A binder layer was then formed on the microsphere-bearing carrier, in generally similar manner as for Working Example 2.4.1 Part C of the '506 application. For convenience, the temporary carrier sheet was usually left in place on the article until such time as the article was to be tested, at which time the carrier sheet was removed and discarded. The resulting retroreflective article, comprising a broad-spectrum non-selective silver reflector layer, was designated as Comparative Example 3.

### Working Example 2

Working Example 2 was prepared by the following procedure. In a first lamination procedure, the Transfer Stack with Silver Reflective Layer described above in Table 3, was laminated to the Polymer Coated Bead Carrier in generally similar manner as for Comparative Example 3. After the first lamination process, both the un-transferred reflective layer and the sacrificial layers of the Transfer Stack were removed from the microsphere-bearing carrier.

In a second, subsequent lamination procedure, a second Transfer Stack, the previously-described visible-reflective Transfer Stack R3502-5, was laminated to the above-described product of the first lamination procedure. This lamination was performed using the pair of 16 inch diameter smooth-faced steel rolls, at a line speed of 3 feet per minute and with a lamination pressure of 1000 pounds per linear inch (PLI). After the lamination process, both the un-transferred reflective layer and the sacrificial layers of the Transfer Stack were removed from the microsphere-bearing carrier. A binder layer was then formed on the microsphere-bearing carrier, in generally similar manner as for Working Example 2.4.1 Part C of the '506 application. For convenience, the temporary carrier sheet was usually left in place on the article until such time as the article was to be tested, at which time the carrier sheet was removed and discarded.

The resulting retroreflective article was designated as Working Example 2.

Working Example 2 was believed to comprise a significant number of transparent microspheres on which were disposed first reflective layers that were silver layers (providing broad-spectrum, non-selective reflectance) in a relatively small, polar-cap configuration resulting from the first, relatively low-pressure lamination process. The majority of transparent microspheres also appeared to have disposed on them second reflective layers, resulting from the second, more aggressive (higher pressure) lamination process. These layers (which were dielectric-stacks tailored for a visible wavelength of maximum reflection) were believed to include at least some spherical segments that at least generally circumscribed the first, silver reflective polar-cap layers.

Retroreflectance of Working Example 2 Versus Comparative Example 3

Working Example 2 and Comparative Example 3 were tested in a “32-angle” retroreflectivity test of the type described in the '506 application. In such a test, the retroreflectivity (R_{A}) is measured at a wide variety of entrance angles (5-40 degrees) and observation angles (0.2-1.5 degrees). Although not reproduced herein, this testing revealed that Working Example 2 consistently exhibited significantly higher retroreflectivity at higher entrance angles in comparison to Comparative Example 3. For example, at 30 degrees entrance angle with an observation angle from 0.2 to 1.5 degrees, the ratio of R_{A} of Working Example 2 to R_{A} of Comparative Example 3 was in a range of 3-5, significantly higher than 1. The results are consistent with the presence of the “in-parallel” portion of the second visible reflective layers, covering a larger angular arc of the microspheres than covered by the first silver reflective layers. It was also noted that Working Example 2 exhibited retroreflectivity in more head-on measurements (e.g. at 5 degrees entrance angle) that was often greater than that exhibited by Comparative Example 3, albeit to a smaller degree (e.g. with a ratio range of 1.2-1.4). It was believed that this indicated that the second lamination process, which was more aggressive than the first lamination process, may have succeeded in transferring the second visible reflective layers (comprising dielectric stacks) to some relatively small number of transparent microspheres that had come through the first lamination process without having a reflective layer transferred thereto. Working Example 2 exhibited the above-described enhanced retroreflectivity (at relatively head-on angles, and particularly at higher entrance angles, as discussed above) without unduly sacrificing color performance. Specifically, Working Example 2 exhibited Y, x and y values of 92, 0.37 and 0.52, which is an excellent result (indicating a bright (fluorescent yellow) color) that is close to the Y, x and y values (103, 0.38 and 0.53) exhibited by Comparative Example 3.

### Comparative Example 4

Comparative Example 4 was prepared following a similar procedure as described for Working Example 2.4.1 in the above-referenced '506 application, using a Transfer Stack that included a silver reflective layer, of a construction as shown in Table 4.

TABLE 4
Transfer Stack w/ Silver Reflective layer
Silver transfer reflector:

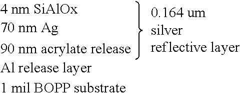

The transfer stack was laminated to the Polymer Coated Bead Carrier, following the same process as described in Comparative Example 3. The silver reflective layer of the Transfer Stack appeared to bond well to the organic polymer layer present on the protruding surfaces of the beads, and to separate from the surrounding reflective layer, so as to achieve the herein-described local lamination. After the lamination process, both the un-transferred reflective layer and the sacrificial layers of the Transfer Stack were removed from the microsphere-bearing carrier, to form a microsphere-bearing carrier with the silver reflector.

A fluorescent yellow binder layer was prepared in generally similar manner as Example 12 of the above-referenced U.S. Provisional Application No. 62/785,344. 51 percent by weight (wt. %) of a copolymer (based on styrene and isoprene with a styrene content of 22%, commercially available as Kraton D1119 from Kraton Corporation, Houston, Tex.), 34 wt. % of a tackifier (commercially available as Westerz 5206 from Ingevity, North Charleston, S.C.), and 15 wt. % a fluorescent lime-yellow pigment powder (provided under the trade designation GT-17 SATURN YELLOW from Day Glo Color Corporation, Cleveland, Ohio) were loaded into a twin-screw extruder and mixed in the extruder at 182° C. for 3 minutes. The mixed composition was then extruded with a contact die at approximately 0.101 millimeter (mm) in coating thickness onto a virgin PET release liner, and then covered by a silicone-coated release liner.

A white binder layer was prepared, following in generally similar manner as for Example 12 of the '344 application. 51 wt. % of a copolymer (based on styrene and isoprene with a styrene content of 22%, commercially available as Kraton D1119 from Kraton Corporation, Houston, Tex.), 34 wt. % of a tackifier (commercially available as Westerz 5206 from Ingevity, North Charleston, S.C.), and 15 wt. % a white pigment powder (provided under the trade name Dupont Ti-Pure R900 available from The Chemours Company, Wilmington, Del.) were loaded into a twin-screw extruder and mixed in the extruder at 182° C. for 3 minutes. The mixed composition was then extruded with a contact die at approximately 0.101 mm in coating thickness onto a virgin PET release liner, and then covered by a silicone-coated release liner.

A white fabric was obtained from Milliken & Co. (Spartanburg, S.C.).

A stack was thus prepared (after removing the release liners from the binder layers) comprising the following layers: the white fabric, the white binder layer, the fluorescent yellow binder layer, and the microsphere-bearing carrier (with the microspheres bearing silver reflector layers as described above). The stack was laminated at 163° C. and 40 pounds per square inch (PSI) for 20 seconds, using a Hix N-800 clamshell laminator. For convenience, the temporary carrier sheet was usually left in place on the article until such time as the article was to be tested, at which time the carrier sheet was removed and discarded. The resulting retroreflective article, comprising a broad-spectrum non-selective silver reflector layer, was designated as Comparative Example 4.

### Working Example 3

A Transfer Stack (designated R3518-3) comprising visible reflective layers in the form of dielectric stacks was prepared following the same general process as described in Working Example 2.3.3.A (Part A) of the '506 application, resulting in a configuration as shown in Table 5. A three-layer elastomeric transfer adhesive film was prepared following the same process as described in Working Example 2.3.1.B (Part B) of the '506 application. The three-layer elastomeric transfer adhesive was laminated to the Transfer Stack R3518-3 using an Akiles ProLam Plus 330 13″ Pouch Laminator (Mira Loma) with a setpoint of 77° C., with the NbOx surface in contact with the elastomeric transfer adhesive surface. The sacrificial layers of the Transfer Stack were then removed from the construction to form an elastomeric transfer adhesive with the weakly bound visible reflective layer.

TABLE 5
Transfer Stack R3518-3
Visible dielectric transfer reflector R3518-3:

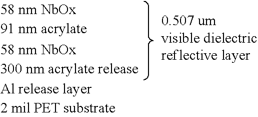

Working Example 3 was prepared by the following procedure. In a first lamination procedure, the Transfer Stack with Silver Reflective Layer described above in Table 4, was laminated to the Polymer Coated Bead Carrier in generally similar manner as for Comparative Example 4. After the first lamination process, both the un-transferred reflective layer and the sacrificial layers of the Transfer Stack were removed from the microsphere-bearing carrier.

In a second, subsequent lamination procedure, the elastomeric transfer adhesive with the weakly bound visible reflective layer was laminated against the above-described product of the first lamination procedure, at 82° C. with a lamination force of 40 PLI. Then the elastomeric transfer adhesive film was removed from the microsphere-bearing carrier to form a microsphere-bearing carrier with the first silver reflector and the second visible reflector.

A stack was thus prepared (after removing the release liners from the binder layers) comprising the following layers: the white fabric, the white binder layer, the fluorescent yellow binder layer, and the microsphere-bearing carrier (with the microspheres bearing first and second reflectors as described above). The stack was laminated at 163° C. and 40 PSI for 20 seconds using a Hix N-800 clamshell laminator. For convenience, the temporary carrier sheet was usually left in place on the article until such time as the article was to be tested, at which time the carrier sheet was removed and discarded. The resulting retroreflective article, comprising a first broad-spectrum non-selective silver reflector layer and a second visible reflector layer, was designated as Working Example 3.

Working Example 3 was thus of a generally similar structure as Working Example 2, in which a significant number of the transparent microspheres comprised a first reflector layer that was a broad-spectrum, non-selective silver layer; and, a second reflector layer that exhibited preferential reflection at a particular visible-light wavelength. The difference between these two Working Examples is that the second reflectors of Working Example 3 were formed by a lamination process that was assisted by a conformal elastomeric substrate (referred to in the Example as an elastomeric transfer adhesive), at a relatively low lamination pressure; whereas, the second reflectors of Working Example 2 were produced by lamination between steel rolls at relatively high lamination pressure.

Retroreflectance of Working Example 3 Versus Comparative Example 4

32-angle retroreflectivity testing of the type described above for Working Example 2, was also performed for Working Example 3 (and for Comparative Example 4). The R_{A} ratios of Working Example 3 to Comparative Example 4 at 40 degree entrance angles (and at an observation angle from 0.2 to 1.5 degrees) were found to be in the range of 8-21. This is significantly higher than the above-discussed R_{A} ratios of Working Example 2 to Comparative Example 3, which (at corresponding entrance/observation angles), were less than 2.5. Thus, Working Example 3 demonstrated enhanced preservation of retroreflectivity at quite high entrance angles (e.g. of up to 40 degrees), in comparison to Working Example 2.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

What is claimed is:

1. A retroreflective article comprising:
a binder layer; and,
a plurality of retroreflective elements spaced over a length and breadth of a front side of the binder layer, each retroreflective element comprising a transparent microsphere partially embedded in the binder layer so as to exhibit an embedded area of the transparent microsphere;
wherein at least some of the retroreflective elements each comprise a first layer that is disposed between the transparent microsphere and the binder layer and that covers a first area of the embedded area of the transparent microsphere;
wherein at least some of the retroreflective elements that comprise a first layer also comprise a second layer that is disposed between the transparent microsphere and the binder layer and that covers a second area of the embedded area of the transparent microsphere,
wherein at least one of the first layer and the second layer is a reflective layer and wherein the first layer and the second layer differ in reflectivity, and
wherein for at least some of the retroreflective elements that comprise a first layer and a second layer, the first area that is covered by the first layer and the second area that is covered by the second reflective layer are non-coextensive, so that at least a portion of the second layer is positioned in-parallel to the first layer so that incident light can reach the in-parallel portion of the second layer without having to pass through the first reflective layer.

2. The retroreflective article of claim 1 wherein for at least some of the retroreflective elements the first layer is a relatively small reflective layer that covers a first, relatively small area of the embedded area of the transparent microsphere; and, the second layer is a relatively large reflective layer that covers a second, relatively large area of the embedded area that is larger than the first, relatively small area.

3. The retroreflective article of claim 2 wherein for at least some of the retroreflective elements the second reflective layer comprises a radially-outward portion that is in-parallel to the first reflective layer and a radially-inward portion that is in-series with the first reflective layer so that incident light cannot reach the in-series portion of the second reflective layer without passing through the first reflective layer.

4. The retroreflective article of claim 3 wherein the radially-outward portion of the second reflective layer is an at least partial spherical segment that at least partially circumscribes the first reflective layer.

5. The retroreflective article of claim 3 wherein the radially-inward portion of the second reflective layer is positioned at least generally rearward of the first reflective layer, between the first reflective layer and the binder layer.

6. The retroreflective article of claim 2 wherein the first reflective layer is positioned at least generally rearward of a radially-inward portion of the second reflective layer, between the radially-inward portion of the second reflective layer and the binder layer.

7. The retroreflective article of claim 1 wherein for at least some of the retroreflective elements the first layer is a reflective layer that is coincident with a front-rear centerline of the transparent microsphere; and, the second layer is a reflective layer configured so that the portion of the second reflective layer that is in-parallel with the first reflective layer is an at least partial spherical segment that at least partially circumscribes the first reflective layer.

8. The retroreflective article of claim 7 wherein for at least some of the retroreflective elements the portion of the second reflective layer that is in-parallel with the first reflective layer is a spherical segment that circumscribes the first reflective layer.

9. The retroreflective article of claim 7 wherein for at least some of the retroreflective elements the second area covered by the second reflective layer is non-overlapping with the first area covered by the first reflective layer, so that the entirety of the second reflective layer is in-parallel to the first reflective layer.

10. The retroreflective article of claim 7 wherein for at least some of the retroreflective elements the second reflective layer comprises a portion that is positioned at least generally rearward of the first reflective layer, between the first reflective layer and the binder layer, and that is in-series with the first reflective layer.

11. The retroreflective article of claim 1 wherein the first reflective layers exhibit, on average, an angular arc of less than 40 degrees and wherein the second reflective layers exhibit, on average, an angular arc of greater than 60 degrees.

12. The retroreflective article of claim 1 wherein the first reflective layers exhibit, on average, an angular arc of at least 80 degrees.

13. The retroreflective article of claim 1 wherein for at least some of the retroreflective elements that comprise first and second reflective layers, the transparent microsphere comprises an embedded area that is not covered by the first reflective layer or the second reflective layer.

14. The retroreflective article of claim 1 wherein the first layers are non-wavelength-selective reflective layers.

15. The retroreflective article of claim 1 wherein the second layers are wavelength-selective reflective layers that exhibit a predetermined wavelength of peak reflection.

16. The retroreflective article of claim 1 wherein the first layer is a first wavelength-selective reflective layer configured to exhibit a first predetermined wavelength of peak reflection that is within the visible light spectrum and wherein the second layer is a second wavelength-selective reflective layer configured to exhibit a second predetermined wavelength of peak reflection that is within the near-IR spectrum.

17. The retroreflective article of claim 1 wherein the first layer is a non-wavelength-selective reflective layer and wherein the second layer is a wavelength-selective reflective layer comprising a dielectric stack, and wherein the second layer exhibits reflectivity whose wavelength depends on the angle of incidence of the light, so that the retroreflective article exhibits an iridescent appearance at least at some angles of incidence.

18. The retroreflective article of claim 1 wherein the first layers and/or the second layers are embedded reflective layers.

19. The retroreflective article of claim 1 wherein the first layers and/or the second layers are localized reflective layers.

20. The retroreflective article of claim 1 wherein the first layers and/or the second layers are bridging reflective layers.

21. The retroreflective article of claim 1 wherein the second layers are non-selective reflective layers comprising metal reflective layers that cover all portions of the embedded areas of the transparent microspheres that are not covered by the first layers.

22. The retroreflective article of claim 1 wherein the first layers and/or the second layers comprise an optical retarder.

23. The retroreflective article of claim 1 wherein the first layers and/or the second layers comprise a colorant.

24. A transfer article comprising the retroreflective article of claim 1 and a disposable carrier layer on which the retroreflective article is detachably disposed with at least some of the transparent microspheres in contact with the disposable carrier layer.

25. A substrate comprising the retroreflective article of claim 1, wherein the binder layer of the retroreflective article is coupled to the substrate with at least some of the retroreflective elements of the retroreflective article facing away from the substrate.

26. An intermediate article comprising:
a disposable carrier layer with a major surface;
a plurality of transparent microspheres partially embedded in the disposable carrier layer so that the transparent microspheres exhibit protruding surface areas;
wherein at least some of the transparent microspheres each comprise a first layer that is present on a portion of the protruding surface area of the transparent microsphere and a second layer that is present on a portion of the protruding surface area of the transparent microsphere,
wherein at least one of the first layer and the second layer is a reflective layer and wherein the first layer and the second layer differ in reflectivity, and
wherein for at least some of the transparent microspheres that comprise a first layer and a second layer, the first area that is covered by the first layer and the second area that is covered by the second layer are non-coextensive.

27. The intermediate article of claim 26 wherein the first layers and the second layers are isolated layers.
